(19) United States
(12) Patent Application Publication
(10) Pub. No.: US 2015/0183679 A1
(43) Pub. Date: Jul. 2, 2015

(54) METHOD FOR CUTTING TEMPERED GLASS PLATE

(71) Applicant: ASAHI GLASS COMPANY, LIMITED, Chiyoda-ku (JP)

(72) Inventor: Isao Saito, Tokyo (JP)

(73) Assignee: ASAHI GLASS COMPANY, LIMITED, Chiyoda-ku (JP)

(21) Appl. No.: 14/588,664

(22) Filed: Jan. 2, 2015

Related U.S. Application Data
(63) Continuation of application No. PCT/JP2013/068290, filed on Jul. 3, 2013.

(30) Foreign Application Priority Data
Jul. 9, 2012 (JP) 2012-153400
Nov. 30, 2012 (JP) 2012-261909

(51) Int. Cl. C03B 33/09

(52) U.S. Cl. CPC C03B 33/091

(57) ABSTRACT

A method for cutting a strengthened glass sheet through laser irradiation. The sheet includes a front surface layer and back surface layer each having a residual compressive stress and an intermediate layer which is formed therebetween and has an internal residual tensile stress CT (MPa). A strain energy U_{CT} (J/m²) expressed by U_{CT}={CT²×(t₁−2×DOL)}/(2×Y) is 2.5 J/m² or more. A cutting index K (N/mm) expressed by K=Pe/v×exp(−α×t₂)×(Y×α_{L})/(t₂×ρ×c) is 150 N/mm or less.

### TECHNICAL FIELD

The present invention relates to a method for cutting a strengthened glass sheet, and particularly to a method for cutting a strengthened glass sheet through internal heating using laser light.

### BACKGROUND ART

In a portable device such as a mobile phone or a personal data assistance (PDA), a glass sheet is used as a cover or substrate of a display. In response to the demand for thickness reduction and weight reduction of the portable device, a strengthened glass sheet having high strength has been used as the glass sheet in order to reduce the thickness and weight.

Generally, the glass sheet is cut by mechanically forming a scribe line on the main surface using a hard roller or chip such as diamond, and applying a bending force along the scribe line. In the above-described method, the formation of the scribe line leads to the generation of a number of fine cracks on the cut edge surface of the glass sheet. As a result, there has been a problem of insufficient strength at a cut edge part in spite of the use of the strengthened glass sheet.

Regarding the above-described problem, recently, the following method has been developed: a strengthened glass sheet is cut by heating the inside of the strengthened glass sheet through the irradiation of laser light, and controlling the propagation of an initial crack that has been formed not on the main surface but on the edge surface of the strengthened glass sheet. In the above-describing cutting using laser light, unlike the related art, it is not necessary to form a scribe line on the main surface of the strengthened glass sheet. Therefore, there are no cases in which the above-described fine cracks are generated on the cut edge surface, and a strengthened glass sheet having high strength can be obtained. Patent Document 1 discloses a method for cutting a glass sheet using laser light.

### CITATION LIST

### Patent Literature

Patent Document 1: WO 2010/126977 A1

### SUMMARY OF INVENTION

### Technical Problem

The present inventors found the following problem regarding the cutting of a strengthened glass sheet using laser light.

In the cutting of a strengthened glass sheet using laser light, the present inventors paid attention to strain energy (internal strain energy) caused by a tensile stress (internal residual tensile stress CT) remaining inside the strengthened glass sheet.

The present inventors found that, when the internal strain energy of the strengthened glass sheet becomes smaller than a certain critical value, the influence of the internal residual tensile stress on the crack propagation becomes small, the irradiation energy of laser light required for cutting is abruptly increased, and it becomes difficult to accurately cut the strengthened glass sheet.

The present invention has been made in consideration of the above-described problem, and an object of the present invention is to accurately cut a strengthened glass sheet using a small irradiation energy in which the crack propagation by an internal residual tensile stress becomes dominant.

### Technical Solution

In the first aspect of the present invention regarding the method for cutting a strengthened glass sheet, the method includes:

cutting a strengthened glass sheet including a front surface layer having a residual compressive stress, a back surface layer having a residual compressive stress and an intermediate layer which is formed between the front surface layer and the back surface layer and has an internal residual tensile stress CT (MPa), by moving an irradiation region of laser light with which the strengthened glass sheet is irradiated,

wherein a strain energy U_{CT} (J/m²) per unit area based on the internal residual tensile stress CT expressed by the following equation using a thickness DOL (μm) of the front surface layer and the back surface layer, a thickness t₁ (μm) of the strengthened glass sheet, and a Young's modulus Y (MPa) is 2.5 J/m² or more, and

a cutting index K (N/mm) expressed by the following equation using an output Pe (W) of the laser light incident on the strengthened glass sheet, a scanning rate v (mm/s) of the laser light, an absorption coefficient α (mm⁻¹) of the strengthened glass sheet with respect to the laser light, a thickness t₂ (mm) of the strengthened glass sheet, the Young's modulus Y (MPa), a linear expansion coefficient α_{L} (K⁻¹), a density ρ (g/mm³), and a specific heat c (J/g/K) is 150 N/mm or less:

U_{CT}={CT²×(t₁−2×DOL)}/(2×Y)

K=Pe/v×exp(−α×t₂)×(Y×α_{L})/(t₂×ρ×c).

In the second aspect of the present invention regarding the method for cutting a strengthened glass sheet, in the method for cutting a strengthened glass sheet according to the first aspect, a beam diameter of the laser light is equal to or less than the thickness of the strengthened glass sheet.

In the third aspect of the present invention regarding the method for cutting a strengthened glass sheet, in the method for cutting a strengthened glass sheet according to the first aspect or second aspect, the strengthened glass sheet is cut by moving the irradiation region of the laser light while controlling propagation of a crack caused by the internal residual tensile stress by locally heating the intermediate layer at a temperature of an annealing point or lower using the laser light with which the strengthened glass sheet is irradiated, and generating a compressive stress in the intermediate layer.

In the fourth aspect of the present invention regarding the method for cutting a strengthened glass sheet, in the method for cutting a strengthened glass sheet according to any one of the first to third aspect, the strengthened glass sheet and the laser light satisfy the condition of 0<α×t₂≦3.0.

In the fifth aspect of the present invention regarding the method for cutting a strengthened glass sheet, in the method for cutting a strengthened glass sheet according to any one of the first to fourth aspect, a wavelength of the laser light is 250 nm to 5000 nm.

In the sixth aspect of the present invention regarding the method for cutting a strengthened glass sheet, in the method for cutting a strengthened glass sheet according to the fifth aspect, the wavelength of the laser light is 2500 nm to 3500 nm.

In the seventh aspect of the present invention regarding the method for cutting a strengthened glass sheet, in the method for cutting a strengthened glass sheet according to any one of the first to sixth aspect, the strengthened glass sheet is cooled by blowing gas to the irradiation region of the laser light from an incident side of the laser light.

In the eighth aspect of the present invention regarding the method for cutting a strengthened glass sheet, in the method for cutting a strengthened glass sheet according to any one of the first to seventh aspect, the strain energy U_{CT} per unit area based on the internal residual tensile stress CT is 60 J/m² or less.

In the ninth aspect of the present invention regarding the method for cutting a strengthened glass sheet, in the method for cutting a strengthened glass sheet according to any one of the first to eighth aspect, the cutting index K is 5 N/mm or more.

### Advantageous Effects of Invention

According to the present invention, the crack propagation by an internal residual tensile stress becomes dominant, and it is possible to accurately cut a strengthened glass sheet using a small irradiation energy.

### BRIEF DESCRIPTION OF DRAWINGS

FIG. 1 is a cross-sectional view of a strengthened glass sheet before irradiation of laser light.

FIG. 2 is a schematic view illustrating the distribution of residual stress in the strengthened glass sheet before irradiation of laser light.

FIG. 3 is a perspective view for explaining a method for cutting the strengthened glass sheet.

FIG. 4 is a cross-sectional view in the direction of the line A-A in FIG. 3.

FIG. 5 is a cross-sectional view in the direction of the line B-B in FIG. 3.

FIG. 6 is a view illustrating an example of a method for cutting out a strengthened glass panel from a strengthened glass sheet.

FIG. 7 is a cross-sectional view of a cooling nozzle to be used in a method for cutting a strengthened glass sheet according to Embodiment 1.

FIG. 8 is a table illustrating the cutting results of a strengthened glass sheet.

FIG. 9 is a table illustrating the cutting results of a non-strengthened glass sheet.

FIG. 10 is a table illustrating the cutting results of a strengthened glass sheet and a non-strengthened glass sheet.

FIG. 11 is a view for explaining a stress acting when a non-strengthened glass sheet is cut using laser light.

FIG. 12 is a view illustrating an example of a stress acting when a strengthened glass sheet is cut using laser light.

FIG. 13 is a view illustrating another example of a stress acting when a strengthened glass sheet is cut using laser light.

FIG. 14 is a view illustrating a shape of a cutting-scheduled line according to Example 1.

FIG. 15 is a table illustrating laser wavelengths λ, internal strain energies U_{CT}, critical irradiation energies Ec, and a variety of conditions for deriving both in Samples 1 to 21.

FIG. 16A is a graph illustrating the internal strain energy U_{CT} dependency of the critical irradiation energy Ec illustrated in the table of FIG. 15.

FIG. 16B is a graph illustrating the internal strain energy U_{CT} dependency of a critical cutting index Kc illustrated in the table of FIG. 15.

FIG. 17 is a table illustrating laser wavelengths λ, internal strain energies U_{CT}, irradiation energies E, a variety of conditions for deriving both, the presence or absence of a black mark as a foreign substance, cutting possibilities, and cross-section properties in Samples 31 to 33 and 41 to 43.

FIG. 18 is a table illustrating laser wavelengths λ, internal strain energies U_{CT}, critical irradiation energies E_{C}, a variety of conditions for deriving both, the formation of a black matrix (BM) film, cutting possibilities, and cross-section properties in Samples 13, 51, and 52.

### DESCRIPTION OF EMBODIMENTS

Hereinafter, specific embodiments to which the present invention is applied will be described in detail with reference to the accompanying drawings, but the present invention is not limited to the following embodiments. In addition, for the clarification of the description, the following description and drawings are appropriately simplified.

### Embodiment 1

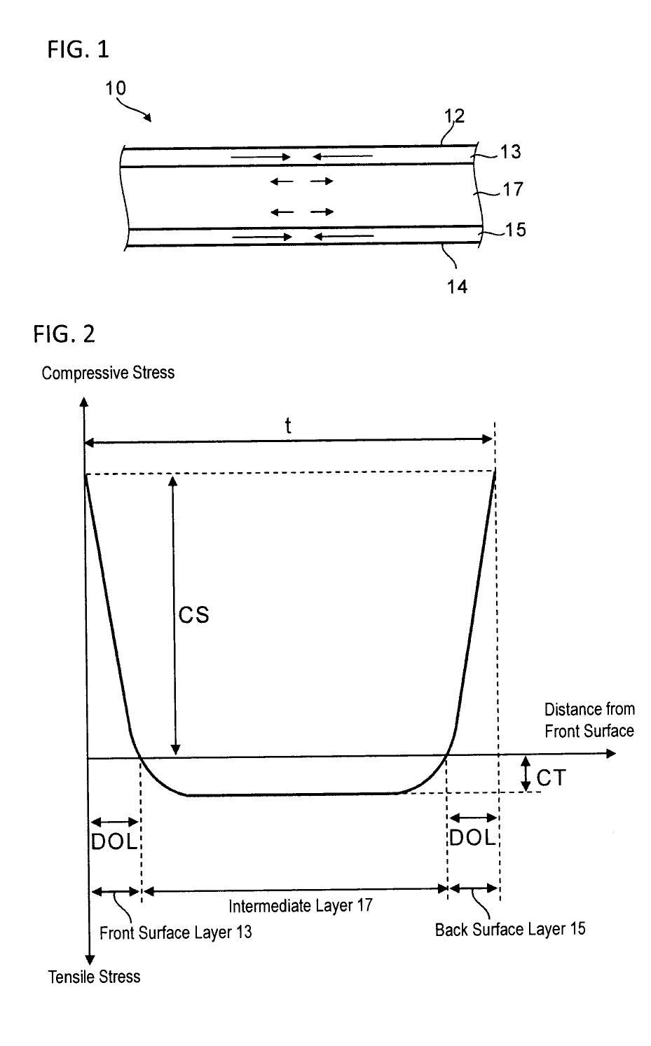

First, the structure of a strengthened glass sheet and a method for cutting the strengthened glass sheet will be described with reference to FIGS. 1 to 5.

The structure of the strengthened glass sheet will be described with reference to FIGS. 1 and 2. FIG. 1 is a cross-sectional view of a strengthened glass sheet 10 before irradiation of laser light. In FIG. 1, the direction of an arrow indicates an acting direction of a residual stress, and the size of the arrow indicates the intensity of the stress. As illustrated in FIG. 1, the strengthened glass sheet 10 includes a front surface layer 13, a back surface layer 15, and an intermediate layer 17 provided between the front surface layer 13 and the back surface layer 15. In the front surface layer 13 and back surface layer 15, a compressive stress generated by the following air-quenching strengthening method or a chemical strengthening method remains. In addition, as a counteraction thereto, a tensile stress remains in the intermediate layer 17.

The strengthened glass sheet 10 is produced by, for example, the air-quenching strengthening method or the chemical strengthening method. The kind of glass for strengthening is selected depending on the usage thereof. For example, in the case of car window glass, building window glass, a glass substrate for a plasma display panel (PDP), and cover glass, alkali aluminosilicate glass or soda-lime glass is used as the glass for strengthening.

In the air-quenching strengthening method, glass at a temperature near the softening point is quenched from the front and back surfaces, and a temperature difference is produced between the front and back surfaces of the glass and the inside of the glass, thereby forming a front surface layer in which a compressive stress remains and a back surface layer in which a compressive stress remains. The air-quenching strengthening method is preferred for the strengthening of thick glass.

In the chemical strengthening method, ions are exchanged in the front and back surfaces of glass, and ions having a small ion radius (for example, Li ions and Na ions) contained in the glass are substituted by ions having a large ion radius (for example, K ions), thereby forming a front surface layer in which a compressive stress remains and a back surface layer in which a compressive stress remains. The chemical strengthening method is preferred for the strengthening of alkali aluminosilicate glass or soda-lime glass.

FIG. 2 is a schematic view illustrating the distribution of a residual stress in the strengthened glass sheet before irradiation of laser light.

As illustrated in FIG. 2, the compressive stresses (>0) remaining in the front surface layer 13 and back surface layer 15 tend to gradually decrease from the front surface 12 and back surface 14 toward the inside of the strengthened glass sheet 10. In addition, the tensile stress (>0) remaining in the intermediate layer 17 tends to gradually decrease from the inside of the glass toward the front surface 12 and back surface 14 of the glass.

In FIG. 2, CS represents a maximum residual compressive stress (surface compressive stress) (>0) in the front surface layer 13 or back surface layer 15, CT represents an internal residual tensile stress (an average value of a residual tensile stress in the intermediate layer 17) (>0) in the intermediate layer 17, DOL represents a thickness of the front surface layer 13 or back surface layer 15, and t represents a thickness of the strengthened glass sheet 10, respectively. Therefore, the thickness of the intermediate layer 17 is represented by t−2×DOL.

Generally, the internal residual tensile stress CT (MPa) in the strengthened glass sheet is calculated by measuring the surface compressive stresses CS (MPa) and the thicknesses DOL (m) of the front surface layer 13 and back surface layer 15, and putting the measured values and the thickness t₁ (μm) of the strengthened glass sheet into the following Equation 1.

CT=(CS×DOL)/(t₁−2×DOL) Equation 1

In addition, the strain energy per unit area based on the internal residual tensile stress CT (hereinafter, simply referred to as “the internal strain energy”) U_{CT} (J/m²) can be obtained from the following Equation 2 using Young's modulus Y (MPa).

U_{CT}={CT²×(t₁−2×DOL)}/(2×Y) Equation 2

The present inventors investigated a minimum value Ec (hereinafter, referred to as the critical irradiation energy) of the irradiation energy E of laser light required to cut strengthened glass sheets having a variety of internal strain energies U_{CT}. As a result, it was found that, when the internal strain energy U_{CT} of the strengthened glass sheet is smaller than 2.5 J/m², the critical irradiation energy Ec is abruptly (specifically, approximately several times) increased in spite of the cutting conditions remaining unchanged, and the cutting accuracy also deteriorates. In addition, the present inventors found that, when the internal strain energy U_{CT} of the strengthened glass sheet is equal to or larger than 2.5 J/m², the critical irradiation energy Ec becomes a substantially constant value, and the cutting accuracy is also improved as long as the material and thickness of the strengthened glass sheet and the laser wavelength are the same. That is, the present inventors found that, when a strengthened glass sheet is cut, in a case where the internal strain energy U_{CT} is equal to or larger than 2.5 J/m², the crack propagation by the internal residual tensile stress becomes dominant, and it is possible to accurately cut the strengthened glass sheet with a small irradiation energy. Meanwhile, when U_{CT} is too large, the strengthened glass sheet breaks due to, as start points, defects such as fine bubbles inside the glass. Therefore, when the maximum bubble size is assumed to be several tens of micrometers which is the quality standard of an ordinary glass sheet, U_{CT} is desirably equal to or smaller than 60 J/m².

That is, it is considered that, at near an internal strain energy U_{CT} of 2.5 J/m², the cutting mode is changed. Specifically, in a case where the internal strain energy U_{CT} as the crack propagation energy for cutting a strengthened glass sheet is smaller than 2.5 J/m², in addition to the internal strain energy, the irradiation energy of laser light is necessary, and, in a case where the internal strain energy U_{CT} is equal to or larger than 2.5 J/m², only the internal strain energy is necessary. In addition, in a case where the internal strain energy U_{CT} is equal to or larger than 2.5 J/m², the irradiation energy of laser light is necessary not only to propagate the crack but also to, conversely, suppress and control the propagation of the crack.

Here, the maximum residual compressive stress CS, the internal residual tensile stress CT, and the thicknesses DOL of the front surface layer 13 and back surface layer 15 can be adjusted based on the strengthening treatment conditions. For example, in the case of the air-quenching strengthening method, the maximum residual compressive stress CS, the internal residual tensile stress CT, and the thicknesses DOL of the front surface layer 13 and back surface layer 15 can be adjusted based on the cooling rate or the like of the glass. In addition, in the case of the chemical strengthening method, the maximum residual compressive stress CS, the internal residual tensile stress CT, and the thicknesses DOL of the front surface layer 13 and back surface layer 15 can be adjusted based on the concentration or temperature of a treatment solution, the immersion time or the like since ions are exchanged by immersing the glass in the treatment solution (for example, KNO₃ molten salt). The front surface layer 13 and the back surface layer 15 in the present embodiment have the same thickness DOL and the same maximum residual compressive stress CS, but may have different thicknesses or different maximum residual compressive stresses.

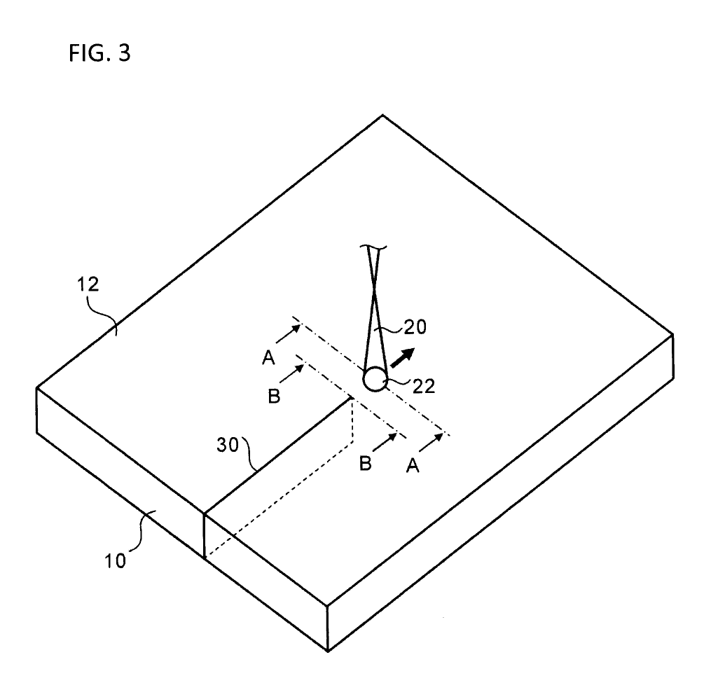

FIG. 3 is a view for explaining a method for cutting the strengthened glass sheet. As illustrated in FIG. 3, a stress is applied to the strengthened glass sheet 10 by irradiating the front surface 12 of the strengthened glass sheet 10 with laser light 20, and moving (scanning) an irradiation region 22 of the laser light 20 on the front surface 12 of the strengthened glass sheet 10, thereby cutting the strengthened glass sheet 10.

In an edge part of the strengthened glass sheet 10, an initial crack has been formed in advance at a cutting start position. A method for forming the initial crack may be an ordinary method, and, for example, the initial crack is formed using a cutter, a file or a laser. As described above, in the internal heating cutting in which laser light is used, it is not necessary to form a scribe line (groove line) along a cutting-scheduled line on the surface 12 of the strengthened glass sheet 10.

On the front surface 12 of the strengthened glass sheet 10, the irradiation region 22 of the laser light 20 is moved in a straight or curved line along the cutting-scheduled line from the edge part to the inside of the strengthened glass sheet 10. Then, a crack 30 is propagated from the edge part to the inside of the strengthened glass sheet 10, thereby cutting the strengthened glass sheet 10.

In order to move the irradiation region 22 of the laser light 20 on the front surface 12 of the strengthened glass sheet 10, a holding tool that supports the strengthened glass sheet 10 may be moved or rotated, or a light source of the laser light 20 may be moved. In addition, a mirror provided on the way of a path of the laser light 20 may be rotated.

On the front surface 12 of the strengthened glass sheet 10, the irradiation region 22 of the laser light 20 is moved at a rate depending on the thickness of the strengthened glass sheet 10, the maximum residual compressive stress CS, the internal residual tensile stress CT, the thicknesses DOL of the front surface layer 13 and back surface layer 15, the output of the light source of the laser light 20 or the like.

The light source of the laser light 20 is not particularly limited, and examples thereof include a UV laser (wavelength: 355 nm), a green laser (wavelength: 532 nm), a semiconductor laser (wavelength: 808 nm, 940 nm, 975 nm), a fiber laser (wavelength: 1060 nm to 1100 nm), a YAG laser (wavelength: 1064 nm, 2080 nm, 2940 nm), a laser in which a mid-infrared light parametric oscillator is used (wavelength: 2600 nm to 3450 nm), and the like. There is no particular limitation regarding a method for oscillating the laser light 20, and any of a CW laser in which laser light is continuously oscillated and a pulse laser in which laser light is intermittently oscillated can be used. In addition, the intensity distribution of the laser light 20 is not limited, and may be a Gaussian type or a Top Hat type.

The laser light 20 emitted from the light source is collected using a collecting lens or the like, and forms an image on the front surface 12 of the strengthened glass sheet 10. The light collection position of the laser light 20 may be on the laser light source side or back surface 14 side of the front surface 12 of the strengthened glass sheet 10. In addition, within a light collection area in which a heating temperature is not too high, that is, the temperature is maintained at an annealing point or lower, the light collection position of the laser light 20 may be in the strengthened glass sheet 10.

On the front surface 12 of the strengthened glass sheet 10, an optical axis of the laser light 20 may, for example, intersect the front surface 12 at right angles as illustrated in FIG. 3 or at an inclined angle.

In a case where the strengthened glass sheet 10 and the laser light 20 satisfy the expression of 0<α×t₂≦3.0 in which α, (mm⁻¹) represents an absorption coefficient of the strengthened glass sheet 10 with respect to the laser light 20, and t₂ (mm) represents a thickness of the strengthened glass sheet 10, it is possible to cut the strengthened glass sheet 10 using not only the action of the laser light 20 but also the propagation of the crack by the residual tensile stress in the intermediate layer 17. That is, when the intermediate layer 17 in the irradiation region 22 of the laser light 20 is heated at a temperature of the annealing point or lower under the above-described conditions, the propagation of the crack 30 generated in the strengthened glass sheet 10 is controlled by generating a tensile stress or compressive stress that is smaller than the value of the internal residual tensile stress in the intermediate layer 17, whereby it becomes possible to cut the strengthened glass sheet 10 using the crack 30 generated by the residual tensile stress. The reason for heating the intermediate layer 17 at a temperature of the annealing point or lower is that, when the intermediate layer 17 is heated at a temperature exceeding the annealing point, the temperature of the glass reaches a high temperature within a short period of time during which the laser light passes through the glass sheet, and a state in which a viscous flow is likely to occur is formed, and therefore the stress generated by the laser light is alleviated due to the viscous flow. The value t₂ (mm) of the thickness t of the strengthened glass sheet 10 is different from the value t₁ (μm) in Equations 1 and 2 only in terms of the units.

When the intensity of the laser light 20 before being incident on the strengthened glass sheet 10 is represented by I₀, and the intensity of the laser light 20 when the laser light has moved through the strengthened glass sheet 10 by a distance L (mm) is represented by I, the following equation is established on the basis of the Lambert-Beer law.

I=I₀×exp(−α×L)

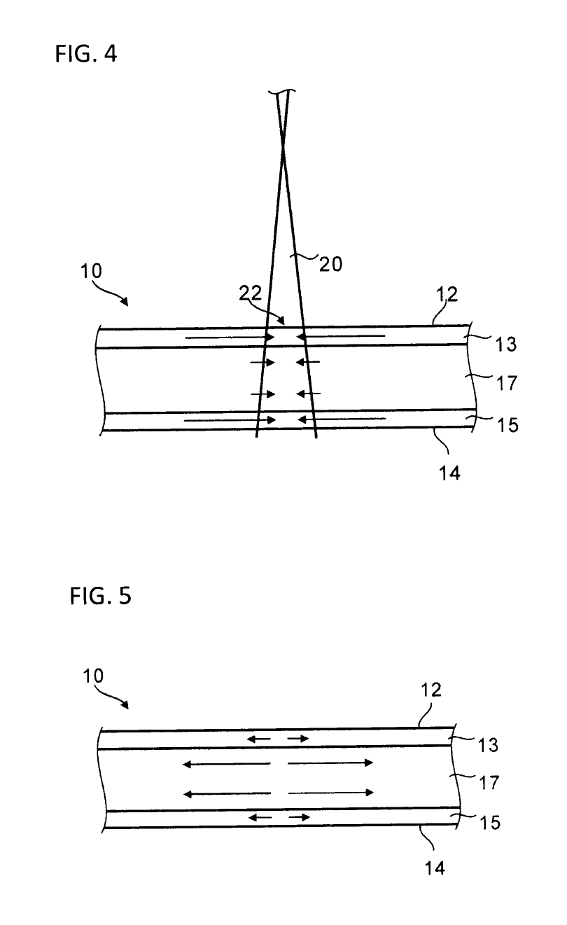

When α×t₂ is larger than 0 and 3.0 or less, the laser light 20 is not absorbed by the front surface of the strengthened glass sheet 10, and reaches the inside of the strengthened glass sheet, and therefore it is possible to sufficiently heat the inside of the strengthened glass sheet 10. As a result, the stress generated in the strengthened glass sheet 10 is changed from the state illustrated in FIG. 1 to a state illustrated in FIG. 4 or 5.

FIG. 4 is a cross-sectional view in the direction of the line A-A in FIG. 3, and is a cross-sectional view including the irradiation region of the laser light. FIG. 5 is a cross-sectional view in the direction of the line B-B in FIG. 3, and illustrates a cross-section behind the cross-section illustrated in FIG. 4. Here, “the cross-section behind the cross-section” means that the former cross-section is located behind the latter cross-section in the scanning direction of the laser light 20. In FIGS. 4 and 5, the direction of an arrow indicates an acting direction of a stress, and the size of the arrow indicates the intensity of the stress.

In the intermediate layer 17 in the irradiation region 22 of the laser light 20, the intensity of the laser light 20 is sufficiently high, and therefore the temperature becomes higher than nearby temperatures, and a tensile stress or compressive stress that is smaller than the residual tensile stress illustrated in FIGS. 1 and 2 is generated. In a part in which the tensile stress or compressive stress that is smaller than the residual tensile stress is generated, the propagation of the crack 30 is suppressed. To reliably prevent the propagation of the crack 30, it is preferable to generate a compressive stress as illustrated in FIG. 4.

As illustrated in FIG. 4, in the front surface layer 13 or back surface layer 15 in the irradiation region 22 of the laser light 20, a compressive stress that is larger than the residual compressive stress illustrated in FIGS. 1 and 2 is generated, and thus, the propagation of the crack 30 is suppressed.

To obtain the balance with the compressive stress illustrated in FIG. 4, in the cross-section behind the cross-section illustrated in FIG. 4, a tensile stress is generated in the intermediate layer 17 as illustrated in FIG. 5. The tensile stress is larger than the residual tensile stress, and the crack 30 is formed at a part at which the tensile stress reaches a predetermined value. The crack 30 penetrates the strengthened glass sheet 10 from the front surface 12 to the back surface 14, and the cutting illustrated in FIG. 3 is so-called full-cut cutting.

In this state, when the irradiation region 22 of the laser light 20 is moved, a tip position of the crack 30 is moved so as to follow the position of the irradiation region 22. That is, in the cutting method illustrated in FIG. 3, when the strengthened glass sheet 10 is cut, the propagation direction of the crack 30 is suppressed by a tensile stress (refer to FIG. 5) generated behind in the scanning direction of the laser light, and the strengthened glass sheet is cut while suppressing the propagation of the crack 30 by using the compressive stress (refer to FIG. 4) generated in a region which is irradiated with the laser light. That is, the propagation of the crack 30 is suppressed by using the compressive stress generated by the irradiation of the laser light 20. As a result, it is possible to suppress the travelling of the crack 30 in a direction deviating from the cutting-scheduled line.

Since glass is required to have high transparency depending on usage thereof, in a case where the wavelength of a laser used is near the wavelength range of visible light, α×t₂ which is close to zero is preferable. However, when α×t₂ is too small, the absorption efficiency becomes poor, and thus α×t₂ is preferably 0.0005 or more (the laser light absorptivity: 0.05% or more), more preferably 0.002 or more (the laser light absorptivity: 0.2% or more), and still more preferably 0.004 or more (the laser light absorptivity: 0.4% or more).

Conversely, since glass is required to have low transparency depending on usage thereof, in a case where the wavelength of a laser used is near the wavelength range of visible light, α×t₂ which is larger is preferable. However, when α×t₂ is too large, the surface absorption of the laser light becomes large, and thus, it becomes impossible to suppress the propagation of the crack. Therefore, α×t₂ is preferably 3.0 or less (the laser light absorptivity: 95% or less), more preferably 0.1 or less (the laser light absorptivity: 10% or less), and still more preferably 0.02 or less (the laser light absorptivity: 2% or less).

The thickness t₂ (mm) of the strengthened glass sheet 10 is set depending on usage thereof, and is preferably 0.1 mm to 2.0 mm. In the case of the chemically strengthened glass, when the thickness t₂ (mm) is 2.0 mm or less, the internal residual tensile stress CT can be sufficiently increased. On the other hand, when the thickness t₂ (mm) is less than 0.1 mm, it is difficult to subject the glass to a chemical strengthening treatment. The thickness t₂ (mm) is more preferably 0.3 mm to 1.5 mm, and still more preferably 0.5 mm to 1.5 mm.

The absorption coefficient α is determined by the wavelength of the laser light 20, the glass composition of the strengthened glass sheet 10 and the like.

For example, the absorption coefficient α in a near-infrared wavelength range near 1000 nm increases as the content of iron oxide (including FeO, Fe₂O₃, Fe₃O₄), the content of cobalt oxide (including CoO, Co₂O₃, CO₃O₄), and the content of copper oxide (including CuO and Cu₂O) in the strengthened glass sheet 10 increases. That is, the value of α×t₂ can be adjusted to a desired range by adjusting the contents of the iron oxide or the like. The content of the iron oxide in the strengthened glass sheet 10 is dependent on the kind of glass constituting the strengthened glass sheet 10, but is 0.02 mass % to 1.0 mass % in the case of soda-lime glass. However, as the contents of the iron oxide or the like increase, the transparency of the strengthened glass sheet 10 in the visible light range degrades.

The absorption coefficient (α) in the near-infrared wavelength range near 1000 nm is set depending on usage thereof. For example, in the case of car window glass, the absorption coefficient (α) is preferably 0.3 mm⁻¹ or less. In addition, in the case of building window glass, the absorption coefficient (α) is preferably 0.06 mm⁻¹ or less. In addition, in the case of glass for a display panel, the absorption coefficient (α) is preferably 0.02 mm⁻¹ or less.

In addition, the absorption coefficient α near the absorption wavelength of rare-earth atoms increases as the content of oxides of rare-earth elements (for example, Yb) in the strengthened glass sheet 10 increases.

Furthermore, the absorption coefficient α in the mid-infrared wavelength range near 3000 nm increases as the content of OH groups in the strengthened glass sheet 10 increases. Here, the content of OH groups does not have any influence on the transparency in the visible light range.

The wavelength of the laser light 20 may need to be 250 nm to 5000 nm, but is preferably 2500 nm to 3500 nm. In a case where the wavelength of the laser light 20 is 2500 nm to 3500 nm (near 3000 nm), as described above, it is possible to increase the absorption coefficient α without degrading the transparency in the visible light range. As a result, it is possible to increase the efficiency of heating by the laser light 20. The wavelength of the laser light 20 is more preferably 2700 nm to 3200 nm.

For example, in a case where the wavelength of the laser light is near 1000 nm, the absorptivity of the strengthened glass sheet having an iron oxide content of 0.04 mass % is approximately 2% (transmittance: approximately 98%) when the sheet thickness t₂ (mm) is 1 mm. Therefore, the efficiency of heating by the irradiation of the laser light is poor. In addition, since the absorptivity varies depending on the concentration of Fe, it is necessary to significantly change the irradiation conditions of the laser light depending on the composition of the strengthened glass sheet.

On the contrary, for example, in a case where the wavelength of the laser light is near 3000 nm, regardless of the iron oxide content, the absorptivity of the strengthened glass sheet is approximately 50% (transmittance: approximately 50%) when the sheet thickness is 1 mm. Therefore, compared with the case in which the wavelength is near 1000 nm, the efficiency of heating is improved, and thus, it is not necessary to significantly change the irradiation conditions of the laser light depending on the composition of the strengthened glass sheet.

In addition, in a case where the absorptivity at a wavelength near 1000 nm is approximately 2%, for example, when an absorption power of 2 W is required for cutting, 100 W is applied, and 98 W is transmitted. Therefore, when a table is located below the cutting-scheduled line through which the laser light passes, the table is damaged by the laser light. Therefore, an effort of using a table that was smaller than a strengthened glass panel cut out from the strengthened glass sheet was required. In addition, a treatment of the laser light that had transmitted was required. Furthermore, since the transmittance was high, there was a case in which reflected light had an adverse influence on the edge surface of the strengthened glass sheet. In addition, when the absorptivity of the laser light was increased due to a foreign substance attached to the front surface or back surface, a change in the absorption amount was large, and an adverse influence was caused. Furthermore, even in a case where the absorptivity is changed only by 1% from 2% to 1% by the concentration of Fe, it is necessary to change the power being applied as much as 100 W from 100 W to 200 W.

On the contrary, in a case where the absorptivity at a wavelength near 3000 nm is approximately 50%, for example, when an absorption power of 2 W is required for cutting, 4 W is applied, and 2 W is transmitted. As described above, compared with the case in which the wavelength is near 1000 nm, it is possible to extremely decrease the power being applied, and improve the efficiency of heating. Therefore, the amount of transmitted light is also extremely decreased, and thus, even when a table is located below the cutting-scheduled line through which the laser light passes, there are no cases in which the table is damaged. Therefore, strengthened glass is placed on a table that is larger than a strengthened glass sheet to be cut, and therefore it is possible to cut the strengthened glass in a more stable state. In addition, a treatment of the laser light that had been transmitted is not required. Furthermore, the power of reflected light on the edge surface of the strengthened glass sheet is also small, and an adverse influence is not easily caused. In addition, even when the absorptivity of the laser light due to a foreign substance attached to the front surface or back surface is increased, a change in the absorption amount is small, and an adverse influence is not easily caused. Furthermore, since the absorptivity does not change due to the concentration of Fe, even in a case where the absorptivity decreases by as much as 10% from 50% to 40%, the power being applied only needs to be changed by 1 W from 4 W to 5 W.

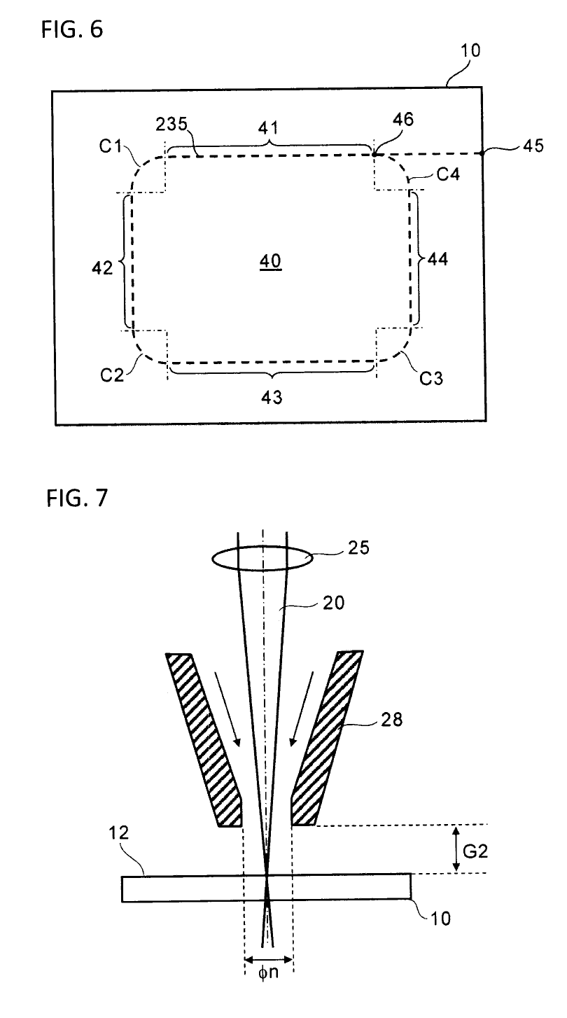

FIG. 6 is a view illustrating an example of a method for cutting out a strengthened glass panel from a strengthened glass sheet. FIG. 6 is a view of a top surface of the strengthened glass sheet 10. In addition, the broken line illustrated on the strengthened glass sheet 10 indicates a cutting-scheduled line 235 for cutting out the strengthened glass panel 40 from the strengthened glass sheet 10 using the above-described cutting method. The strengthened glass panel 40 has a rectangular shape having four corner sections C1, C2, C3, and C4, which have a predetermined curvature radius R, and straight sections 41, 42, 43, and 44. The shape of the strengthened glass panel 40 illustrated in FIG. 6 is an example, and the method for cutting strengthened glass according to the present embodiment can be used even in a case where a strengthened glass panel 40 having another arbitrary shape is cut out from the strengthened glass sheet 10.

When the strengthened glass panel 40 is cut out from the strengthened glass sheet 10, the laser light is scanned so as to pass through the cutting-scheduled line 235. Specifically, the scanning of the laser light is started from a cutting start position 45 located on the edge surface on an imaginary line extending from the straight section 41. Then, the laser light is scanned so as to pass through the straight section 41, the corner section C1, the straight section 42, the corner section C2, the straight section 43, the corner section C3, the straight section 44, and the corner section C4, and then reaches the cutting end position 46, which is a connection point between the corner section C4 and the straight section 41. At this time, an initial crack is formed in advance at the cutting start position 45, that is, on the edge part of the strengthened glass sheet 10. The initial crack can be formed using, for example, a cutter, a file or a laser.

In the method for cutting a strengthened glass sheet according to the present embodiment, the irradiation region 22 of the laser light 20 is cooled by blowing air. FIG. 7 is a cross-sectional view of a cooling nozzle to be used in a method for cutting a strengthened glass sheet according to Embodiment 1. Gas is blown to the surface 12 of the strengthened glass sheet 10 from the cooling nozzle 28 illustrated in FIG. 7. As illustrated in FIG. 7, in the cooling nozzle 28, a taper-shaped air hole is formed so that the gas (air, nitrogen or the like) flows inside the nozzle in the arrow direction. The axis of the cooling nozzle 28 coincides with the optical axis of the laser light, and the laser light 20 collected using a lens 25 passes through the inside of the cooling nozzle 28, and is emitted from an opening part which is provided at the top of the cooling nozzle 28 and has a diameter φn. In addition, the cooling nozzle can be moved in synchronization with the movement of the irradiation region of the laser light (that is, at the same scanning rate as the laser light). In the above-described constitution, laser-irradiated parts are cooled using gas. The cooling shortens the distance between the tip position of the crack 30 illustrated in FIG. 3 and the irradiation region 22 of the laser light 20, and improves the cutting accuracy.

The diameter φn of the opening part in the cooling nozzle 28, and a gap G2 between the tip of the cooling nozzle 28 and the front surface 12 of the strengthened glass sheet 10 can be arbitrarily determined. As the diameter φn of the opening part in the cooling nozzle 28 decreases, the flow rate of the gas blown to the strengthened glass sheet 10 increases, and the cooling capability on the front surface 12 of the strengthened glass sheet 10 improves. In addition, as the gap G2 between the tip of the cooling nozzle 28 and the front surface of the strengthened glass sheet 10 decreases, the cooling capability on the front surface 12 of the strengthened glass sheet 10 improves.

### Reference Examples

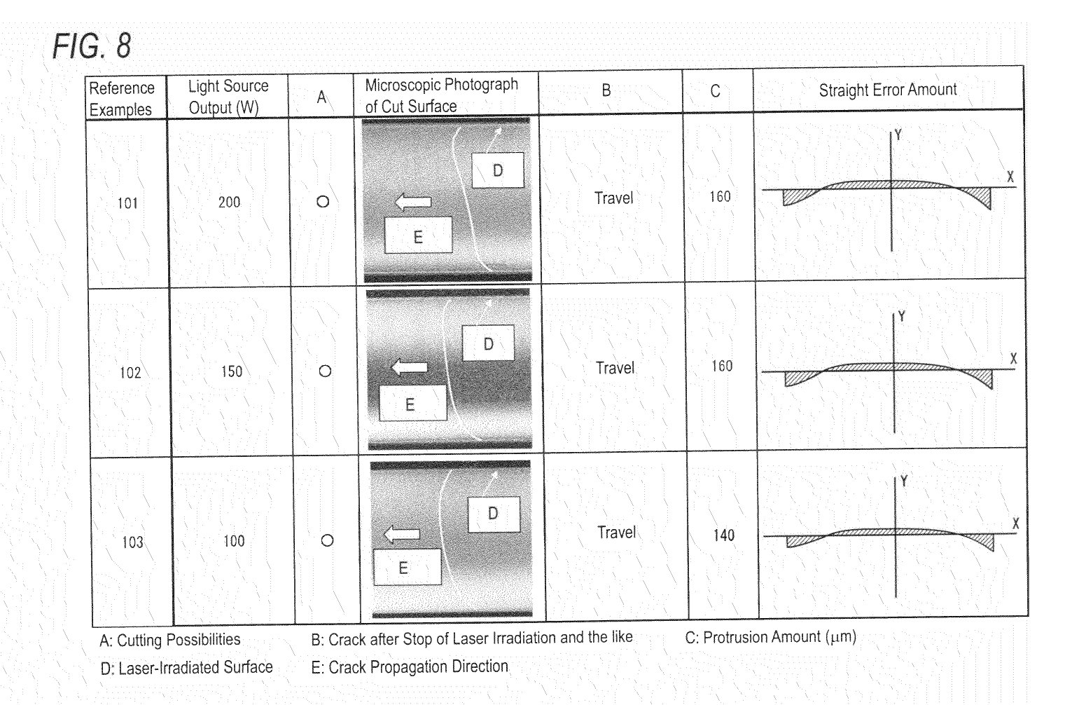

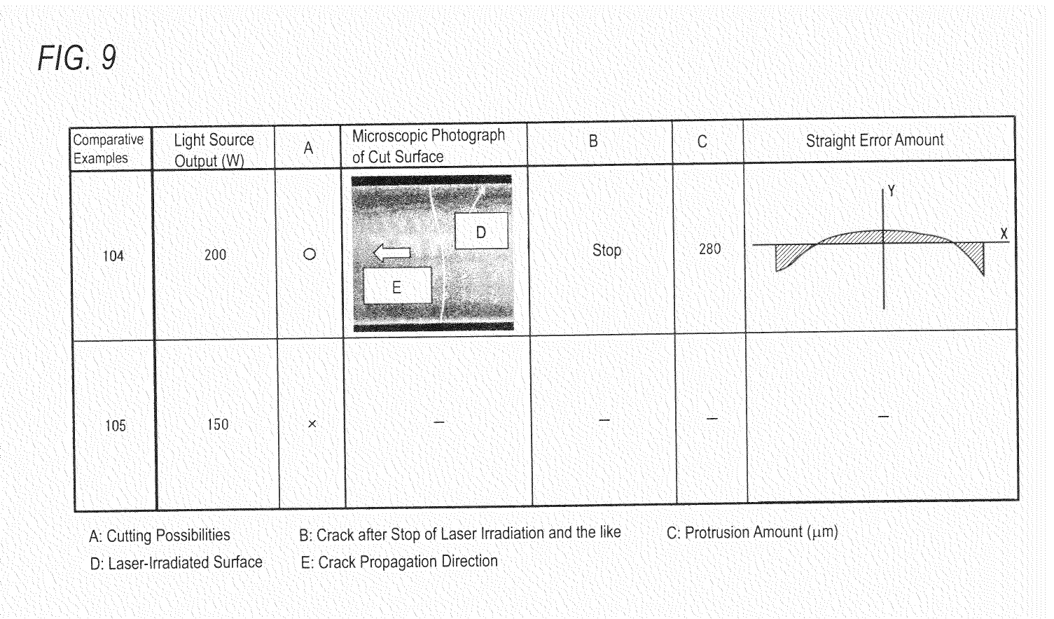

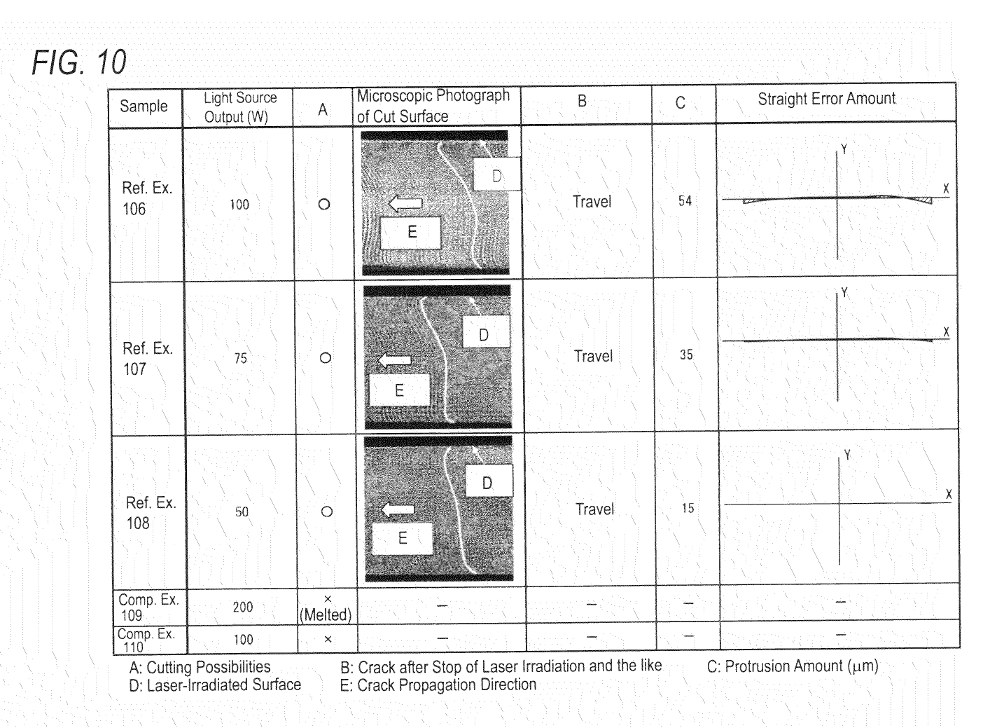

Here, the difference in the behavior of the propagation of the crack between the method for cutting a strengthened glass sheet and a method for cutting a non-strengthened glass sheet will be described with reference to FIGS. 8 to 10. FIG. 8 is a table illustrating the cutting results in the case of a strengthened glass sheet. FIG. 9 is a table illustrating the cutting results in the case of a non-strengthened glass sheet. FIG. 10 is a table illustrating the cutting results in the case of a strengthened glass sheet (Reference Examples) and a non-strengthened glass sheet (Comparative Examples). The cutting results described in FIG. 10 are cutting results in a case where a spot diameter of the laser light is set to be smaller than those in the cutting results illustrated in FIGS. 8 and 9.

In Reference Examples 101 to 103 and 106 to 108, strengthened glass sheets were prepared, and in Comparative Examples 104 and 105, and 109 and 110, non-strengthened glass sheets were prepared. The strengthened glass sheets in Reference Examples 101 to 103 and 106 to 108 were produced by strengthening glass sheets having the same dimensions, shape (rectangular shape, long side 100 mm, short side 60 mm, sheet thickness 0.7 mm), and chemical composition as the non-strengthened glass sheets in Comparative Examples 104 and 105, and 109 and 110, by the use of the chemical strengthening method. The strengthened glass sheets had an internal residual tensile stress (CT) of 30.4 MPa, a maximum residual compressive stress (CS) of 763 MPa, and a thickness (DOL) of a compressive stress layer (the front surface layer or back surface layer) of 25.8 μm. Here, the internal strain energy U_{CT} was 4.04 J/m².

In Reference Examples 101 to 103, 106 to 108, and Comparative Examples 104 and 105, and 109 and 110, cutting tests were carried out under the same conditions except for the type of the glass sheets (strengthened or non-strengthened), the output of a light source, and the laser spot diameter.

<Common Conditions>

Light source of the laser light: fiber laser (wavelength 1070 nm)

Incident angle of the laser light on the glass sheet: 0°

Light collection angle of the laser light: 2.5°

Light collection position of the laser light: a position 23 mm away from the front surface of the glass sheet toward the light source

Laser spot diameter on the front surface of the glass sheet: φ1 mm

Absorption coefficient α of the glass sheet with respect to the laser light: 0.09 cm⁻¹ (0.009 mm⁻¹)

Sheet thickness t of the glass sheet: 0.07 cm (0.7 mm)

Young's modulus Y of the glass sheet: 74000 MPa

α×t: 0.0063

Outlet diameter of a nozzle: φ1 mm

Flow rate of cooling gas (compressed air at room temperature) from the nozzle: 30 L/min

Target cutting position: a straight line in parallel with the short side of the glass sheet (10 mm away from one short side and 90 mm away from the other short side)

Cutting rate: 2.5 mm/s

In Reference Examples 101 to 103 and Comparative Examples 104 and 105 described in FIGS. 8 and 9, the laser spot diameter φ on the front surface of the glass sheet was 1 mm. In addition, in Reference Examples 106 to 108 and Comparative Examples 109 and 110 described in FIG. 10, the laser spot diameter φ on the front surface of the glass sheet was 0.1 mm.

After cutting, the cut surfaces of the glass sheets were observed using a microscope. The stripe patterns observed on the cut surfaces of the glass sheets indicate the temporal changes of the tip position of the intermittently-propagating cracks. From the shape of each line in the stripe pattern, the appearance of the propagation of the crack can be observed. In the microscopic photographs illustrated in FIGS. 8 to 10, typical lines of the stripe patterns are highlighted using thick white lines.

In addition, on the way of the cutting of the glass sheets, the appearance of the cracks when the laser irradiation and the gas cooling were stopped was visually observed.

The respective test results are described in FIGS. 8 to 10. In FIGS. 8 to 10, the case in which a crack was formed in the glass sheet (the case in which the glass sheet could be cut) was indicated by “O”, and the case in which a crack was not formed in the glass sheet (the case in which the glass sheet could not be cut) was indicated by “X”.

The lines in the stripe patterns on the microscopic photographs of the cut surfaces in FIGS. 8 to 10 indicate the tip positions of the cracks at a certain point in time.

The “travel” in FIGS. 8 to 10 means that, after the stoppage of the laser irradiation and the like, the crack propagates toward one of two short sides of the glass sheet which is closer to the cutting position.

The protrusion amount and the straight error amount indicate error amounts when the glass sheet is cut. That is, these amounts indicate the amounts of deviation (indicated by the Y axis in the graph) of the cut line of the glass sheet from the cutting-scheduled line (indicated by the X axis in the graph) when the top surface of the glass sheet is observed. As the protrusion amount and the straight error amount (that is, the absolute value of the Y axis) decrease, the glass sheet is cut better along the cutting-scheduled line.

As illustrated in FIG. 9, in the cutting of the non-strengthened glass sheets according to Comparative Examples 104 and 105, as is clear from the microscopic photographs of the cut surfaces, both edge parts of the glass sheet in the sheet thickness direction tended to be cracked earlier than the crack in the center part of the glass sheet in the sheet thickness direction. In addition, when the laser irradiation and the gas cooling were stopped on the way of cutting, the propagation of the crack was stopped. Furthermore, in the cutting of the non-strengthened glass sheets, a large light source output was required. In addition, in the cutting of the non-strengthened glass sheets, the protrusion amount and the straight error amount were increased.

On the contrary, in the cutting of the strengthened glass sheets according to Reference Examples 101 to 103 illustrated in FIG. 8, as is clear from the microscopic photographs of the cut surfaces, the center part of the glass sheet in the sheet thickness direction tended to be cracked earlier than the crack in both edge parts of the glass sheet in the sheet thickness direction. This is because, originally, a residual tensile stress is present inside the strengthened glass sheet, and the crack is propagated by the residual tensile stress. In addition, when the laser irradiation and the gas cooling were stopped on the way of cutting, the crack propagated in an unintended direction. From this result, it is found that the propagation of the crack by the residual tensile stress is suppressed by the irradiation of the laser light. In addition, in the cutting of the strengthened glass sheets, the protrusion amount and the straight error amount were smaller than those in the case of the cutting of the non-strengthened glass sheets. The similar results were obtained in the cutting of the strengthened glass sheets in Reference Examples 106 to 108 illustrated in FIG. 10.

In addition, as illustrated in FIG. 10, in a case where the laser spot diameter was small (Reference Examples 106 to 108), it was possible to cut the strengthened glass sheet using a smaller light source output than the cases in Reference Examples 101 to 103. In addition, in Reference Examples 106 to 108, the protrusion amount and the straight error amount were small compared with the cases of Reference Examples 101 to 103 illustrated in FIG. 8. That is, in Reference Examples 106 to 108, it was possible to more accurately cut the strengthened glass sheets than the cases in Reference Examples 101 to 103. In addition, as described in Reference Examples 106 to 108, as the light source output decreased, the protrusion amount and the straight error amount decreased. Particularly, in Reference Example 108, the protrusion amount was an extremely small value of 15 μm.

On the other hand, in a case where the laser spot diameter was small, it was not possible to cut the non-strengthened glass sheet. That is, as described in Comparative Example 109, in a case where the output of the light source was 200 W, it was not possible to cut the non-strengthened glass sheet since the non-strengthened glass sheet was melted. That is, the temperature of the non-strengthened glass sheet reached the annealing point or higher, and it was not possible to cut the non-strengthened glass sheet. In addition, as described in Comparative Example 110, in a case where the output of the light source was 100 W, there was no change in the non-strengthened glass sheet. Therefore, in a case where the laser spot diameter was small (for example, less than the sheet thickness), it was not possible to cut the non-strengthened glass sheet regardless of the output of the light source.

As described above, between the method for cutting a strengthened glass sheet and the method for cutting a non-strengthened glass sheet, the cutting mechanisms are basically different, and the behaviors of the propagation of the crack are totally different. Therefore, in the present invention, effects that cannot be predicted from the method for cutting a non-strengthened glass sheet can be obtained. The reasons will be described below.

For example, in the method for cutting a non-strengthened glass sheet, a thermal stress field is formed in the glass sheet using both the laser light and a cooling fluid, and a tensile stress necessary for cutting is generated. More specifically, a thermal stress is generated inside the glass sheet by irradiating the glass sheet with the laser light, a compressive stress generated by the thermal stress is quenched using the cooling fluid, and a tensile stress is generated, thereby making the crack propagate. Therefore, the crack is propagated only by the irradiation energy of the laser light, and it is necessary to set the power (W) of a laser with which the glass sheet is irradiated to be large.

In the above-described method, the tip position of a fractured fissure formed in the glass sheet is determined by the position of the cooling fluid that cools the glass sheet. This is because a tensile stress is generated at the position of the cooling fluid. Therefore, when the heating using the laser light or the cooling using the cooling fluid is stopped on the way of cutting, the propagation of the crack is stopped.

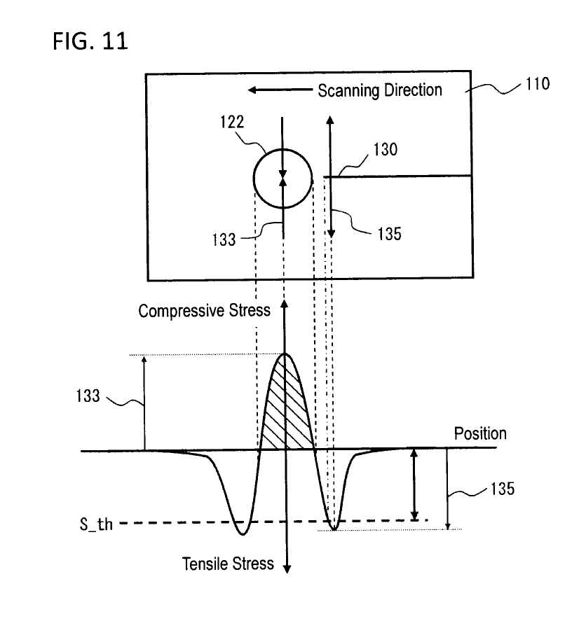

FIG. 11 is a view for explaining a stress acting when the non-strengthened glass sheet is cut using the laser light. FIG. 11 illustrates the top surface view of a non-strengthened glass sheet 110 and the distribution of stresses generated in the sheet thickness center part of the non-strengthened glass sheet 110. As illustrated in FIG. 11, when the non-strengthened glass sheet 110 is irradiated with the laser light, a compressive stress 133 acts in an irradiation region 122 of the laser light. This compressive stress 133 is a thermal stress generated by the irradiation of the laser light. In addition, a tensile stress 135 is generated behind the irradiation region 122 in the scanning direction so as to balance with the compressive stress 133. The non-strengthened glass sheet 110 is cut by acting the tensile stress 135 on a crack 130.

As illustrated in the graph of FIG. 11, in the non-strengthened glass sheet 110, the internal residual tensile stress CT is approximately zero. Therefore, the tensile stress 135 acting on the crack 130 when the non-strengthened glass sheet 110 is cut is generated only by the irradiation of the laser light. Therefore, in order to increase the tensile stress 135, it is necessary to increase the irradiation energy of the laser light or increase the laser spot diameter. Therefore, in the non-strengthened glass sheet 110, the absorptivity of the laser light is small, and it becomes difficult to cut the glass.

In addition, when the non-strengthened glass sheet 110 is cut, the propagation of the crack is controlled using the irradiation energy of the laser light and the scanning rate. At this time, when the irradiation energy of the laser light is smaller than the irradiation energy necessary for cutting, the propagation of the crack stops. That is, as illustrated in the graph of FIG. 11, in order to propagate the crack 130, it is necessary for a tensile stress larger than a tensile stress S_th necessary for the propagation of the crack 130 to act on the crack 130. In the non-strengthened glass sheet 110, since the internal residual tensile stress CT is approximately zero, it is necessary to generate a tensile stress larger than the value of the tensile stress S_th using only the irradiation energy of the laser light.

On the contrary, in the method for cutting a strengthened glass sheet, since the internal residual tensile stress is originally present inside the glass sheet, unlike the case of the cutting of the non-strengthened glass sheet, it is not necessary to generate a large tensile stress using only the irradiation energy of the laser light. In addition, in a case where the internal residual tensile stress is a tensile stress larger than the tensile stress S_th necessary for the propagation of the crack, when a crack is generated due to any force acting on the strengthened glass sheet, the crack propagates on its own due to the internal residual tensile stress. On the other hand, since the internal residual tensile stress is present throughout the inside of the glass sheet, the crack propagates in an unintended direction as long as the propagation of the crack is not controlled.

Therefore, in the present invention, the propagation of the crack generated by the internal residual tensile stress is suppressed by generating a tensile stress or compressive stress smaller than the value of the internal residual tensile stress in the intermediate layer at the center of the irradiation region. That is, the propagation of the crack is controlled by making the residual tensile stress in the intermediate layer of the strengthened glass sheet smaller than the tensile stress S_th necessary for the propagation of the crack by the irradiation of the laser light.

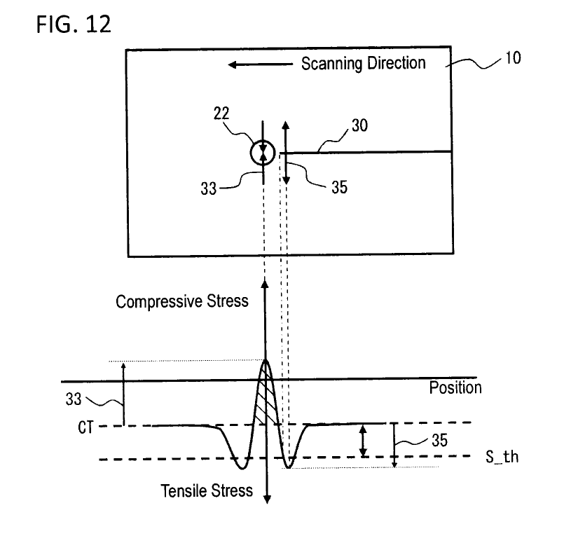

FIG. 12 is a view illustrating an example of a stress acting when the strengthened glass sheet is cut using laser light. FIG. 12 illustrates the top surface view of the strengthened glass sheet 10 and the distribution of stresses generated in the sheet thickness center part of the strengthened glass sheet 10. As illustrated in FIG. 12, when the strengthened glass sheet 10 is irradiated with the laser light, a compressive stress 33 acts in the irradiation region 22 of the laser light. In addition, the tensile stress 35 is generated behind the irradiation region 22 in the scanning direction. In addition, the addition of the internal residual tensile stress to the tensile stress 35 generates a tensile stress larger than the tensile stress S_th necessary for the propagation of the crack, and the strengthened glass sheet 10 is cut by the tensile stress acting on the crack 30. At this time, the propagation of the crack 30 is controlled by the compressive stress 33.

As illustrated in a graph of FIG. 12, in the strengthened glass sheet 10, the internal residual tensile stress CT is present. Therefore, the tensile stress 35 necessary for the propagation of the crack 30 is small. In other words, it is possible to decrease the compressive stress 33 generated by the laser light necessary for making a tensile stress larger than the tensile stress S_th (the tensile stress necessary for the propagation of the crack 30) act on the crack 30.

Here, since it is possible to decrease the compressive stress 33 or tensile stress 35 necessary when the strengthened glass sheet 10 is cut to be smaller than a stress necessary when the non-strengthened glass sheet 110 is cut, it is possible to decrease the irradiation energy of the laser light or decrease the laser spot diameter. Therefore, it is possible to improve the cutting accuracy. In addition, it is possible to easily cut glass having a small absorptivity of the laser light.

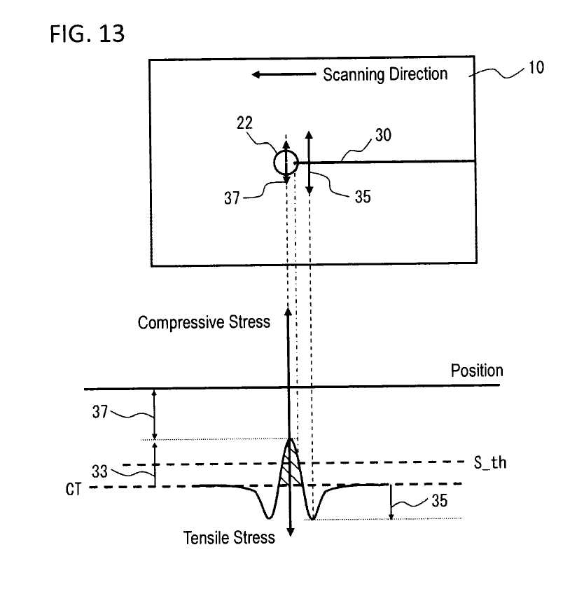

FIG. 13 is a view illustrating another example of a stress acting when the strengthened glass sheet is cut using the laser light. FIG. 13 illustrates the top surface view of the strengthened glass sheet 10 and the distribution of stresses generated in the sheet thickness center part of the strengthened glass sheet 10. In the strengthened glass sheet 10 illustrated in FIG. 13, the internal residual tensile stress CT is larger than the tensile stress S_th necessary for the propagation of the crack 30. That is, as illustrated in FIG. 13, when the strengthened glass sheet 10 is irradiated with the laser light, a tensile stress 37 that is smaller than the value of the internal residual tensile stress CT is generated in the irradiation region 22 of the laser light. Here, the tensile stress 37 is the total force of the compressive stress 33 generated by the irradiation of the laser light and the internal residual tensile stress CT. In addition, the tensile stress 35 is generated behind the irradiation region 22 in the scanning direction. In this case, it is possible to suppress the propagation of the crack 30 by making the tensile stress 37 smaller than the value of the internal residual tensile stress CT smaller than the tensile stress S_th necessary for the propagation of the crack 30.

In the case illustrated in FIG. 13 as well, since it is possible to decrease the tensile stress 37 or tensile stress 35 which is necessary when the strengthened glass sheet 10 is cut and is smaller than the value of the internal residual tensile stress CT to be smaller than the stress necessary for cutting the non-strengthened glass sheet 110, it is possible to decrease the irradiation energy of the laser light or decrease the laser spot diameter. Therefore, it is possible to improve the cutting accuracy. In addition, it is possible to easily cut glass having a small absorptivity of the laser light.

As described above, when the strengthened glass sheet 10 is cut, the propagation of the crack 30 is controlled without allowing the crack 30 to travel by maintaining the balance among the internal residual tensile stress CT, the irradiation energy and scanning rate of the laser light. Therefore, when the irradiation energy of the laser light is too small, the tensile stress 37 smaller than the value of the internal residual tensile stress CT becomes larger than the tensile stress S_th necessary for the propagation of the crack 30, and the propagation of the crack 30 does not stop, and travels without stopping (in the case of FIG. 13).

As described above, between the method for cutting a strengthened glass sheet and the method for cutting the non-strengthened glass sheet, the cutting mechanisms are basically different, and the behaviors of the propagation of the crack are totally different. Therefore, in the present invention, effects that cannot be predicted from the method for cutting a non-strengthened glass sheet can be obtained.

### EXAMPLES

Hereinafter, specific examples of the present invention will be described. In Example 1, a relationship between the internal strain energy U_{CT} and the critical irradiation energy Ec which is the minimum value of the irradiation energy E at which the glass sheet can be cut will be described.

### Example 1

In Example 1, for 21 samples (Samples 1 to 21) having different internal strain energies U_{CT}, the relationships with the critical irradiation energy Ec were investigated. In Samples 18 to 21, non-strengthened glass sheets were used.

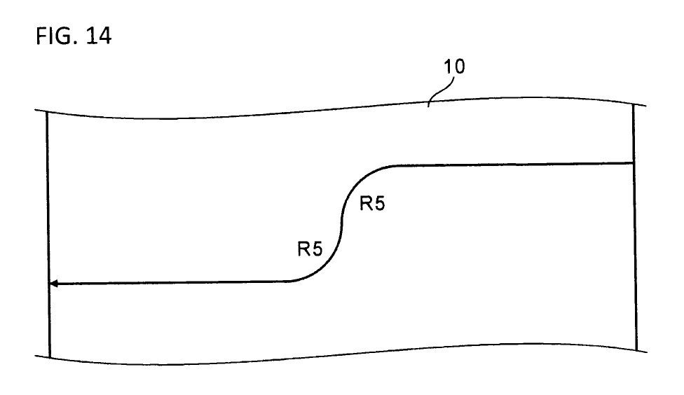

FIG. 14 is a view illustrating the shape of a cutting-scheduled line according to Example 1. As illustrated in FIG. 14, the cutting-scheduled line according to Example 1 includes two straight sections and two corner sections (curvature radius R=5 mm) constituting a crank shape.

For glass sheets for chemical strengthening, a glass raw material adjusted by mixing a plurality of kinds of raw materials was dissolved, and the dissolved molten glass was formed into a sheet shape. After the glass was slowly cooled to near room temperature, the glass was cut, machined, and mirror-polished on both surfaces, thereby producing 50 mm×50 mm glass sheets having a predetermined thickness. The glass raw materials were prepared by changing the amount of iron oxide (Fe₂O₃) powder added to a base material having the same blending ratio thereto so that the absorption coefficient α of the glass sheet with respect to laser light reached a predetermined value.

The respective glass sheets for chemical strengthening included, in terms of mass % on the basis of oxides, SiO₂: 60.9%, Al₂O₃: 12.8%, Na₂O: 12.2%, K₂O: 5.9%, MgO: 6.7%, CaO: 0.1%, SrO: 0.2%, BaO: 0.2%, and ZrO₂: 1.0%, and included a predetermined amount of iron oxide (Fe₂O₃) by an outer percentage.

The respective strengthened glass sheets were produced by immersing the glass sheets for chemical strengthening in a KNO₃ molten salt, carrying out an ion exchange treatment, and then cooling down to near room temperature. The treatment conditions such as the temperature of the KNO₃ molten salt and the immersion time were set so that the internal residual tensile stress CT reached a desired value.

The internal residual tensile stress CT (MPa) of the strengthened glass sheet was calculated by measuring the surface compressive stress CS (MPa) using a surface stress meter FSM-6000 (manufactured by Orihara Industrial Co., Ltd.) and the thicknesses DOL (μm) of the compressive stress layers (the front surface layer and the back surface layer), and putting the measured values and the thickness t₁ (μm) of the strengthened glass sheet into the following Equation 1.

CT=(CS×DOL)/(t₁−2×DOL) Equation 1

The internal strain energy U_{CT} (J/m²) was obtained from the following Equation 2 using the Young's modulus Y (MPa) of the strengthened glass sheet.

U_{CT}={CT²×(t₁−2×DOL)}/(2×Y) Equation 2

The irradiation energy (J/m²) of the laser light per unit irradiation area can be expressed as Pe/(v×φ) where the effective laser output of the laser light that is successfully incident on the strengthened glass sheet without being reflected is represented by Pe (W), the scanning rate of the laser light is represented by v (mm/s), and the beam diameter of the laser light with which the strengthened glass sheet 10 is irradiated is represented by φ (mm). Here, the effective laser output Pe (W) can be expressed as Pe=P×(1−r/100) using the laser output P (W) and the reflectivity r (%) on the strengthened glass sheet. However, to determine the cutting properties, it is preferable to use the irradiation energy E (J/mm) of the laser light per unit length obtained by multiplying the effective laser output by the beam diameter φ (mm). The detailed reasons will be described below. The irradiation energy E (J/mm) is expressed by the following Equation 3.

E=Pe/v Equation 3

The critical irradiation energy Ec, which was the critical value of the irradiation energy E for Samples 1 to 11, was obtained by repeating cutting while changing the irradiation energy E at intervals of approximately 1 (J/mm). At this time, only the laser output P (W) was changed at intervals of 2.5 W while the scanning rate v (mm/s) of the laser light was fixed.

In addition, the critical irradiation energy Ec for Samples 18 to 21 of the non-strengthened glass sheets was obtained by repeating cutting while changing the irradiation energy E at intervals of approximately 4 (J/mm). At this time, only the laser output P (W) was changed at intervals of 10 W while the scanning rate v (mm/s) of the laser light was fixed.

On the other hand, the critical irradiation energy Ec for Samples 12 to 17 was obtained by repeating cutting while the irradiation energy E was gradually changed. At this time, only the scanning rate v (mm/s) of the laser light was changed at intervals of 0.25 mm/s while the laser output P (W) was fixed.

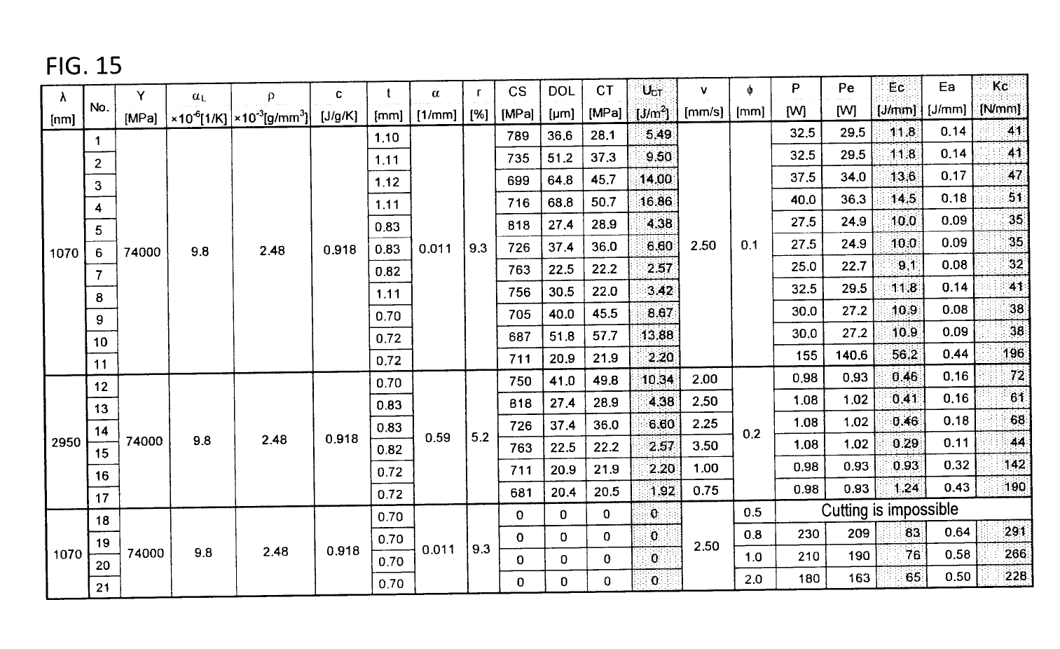

FIG. 15 is a table illustrating the laser wavelengths λ, the internal strain energies U_{CT}, the critical irradiation energies Ec, and a variety of conditions for deriving both in Samples 1 to 21. From the leftmost column of the table, the laser wavelength λ (nm), sample numbers, the Young's moduli Y (MPa) of the strengthened glass sheets, the linear expansion coefficient α_{L} (K⁻¹), the density ρ (g/mm³), the specific heat c (J/g/K), the thickness t (mm), the absorption coefficients α (mm⁻¹), the reflectivity r (%) on the strengthened glass sheets, the surface compressive stress CS (MPa), the thicknesses DOL (μm) of the front surface layer and the back surface layer, the internal residual tensile stress CT (MPa), the internal strain energy U_{CT} (J/m²), the scanning rate v (mm/s) of the laser light, the beam diameter φ (mm) of the laser light, the laser output P (W), the effective laser output Pe (W), the critical irradiation energy Ec (J/mm), the critical absorption energy Ea (J/mm), and the critical cutting index Kc (N/mm) are sequentially illustrated.

As described in FIG. 15, in Samples 1 to 11 and 18 to 21, a fiber laser (central wavelength band: 1070 nm) was used, and in Samples 12 to 17, a Cr:ZnSe laser (central wavelength band: 2950 nm) in which a mid-infrared light parametric oscillator was used as a light source of the laser light was used.

In addition, since the same material was used for all the samples, as described in FIG. 15, the Young's modulus Y of 74000 MPa, the linear expansion coefficient α_{L} of 9.8×10⁻⁶ K⁻¹, the density ρ of 2.48×10⁻³ g/mm³, and the specific heat c of 0.918 J/g/K were common.

As described in FIG. 15, in Samples 1 to 11, the beam diameter φ was set to 0.1 mm, and in Samples 12 to 17, the beam diameter φ was set to 0.2 mm. In addition, for the non-strengthened glass sheet of Sample 18, the beam diameter φ was set to 0.5 mm, for Sample 19, the beam diameter φ was set to 0.8 mm, for Sample 20, the beam diameter φ was set to 1.0 mm, and for Sample 21, the beam diameter φ was set to 2.0 mm.

In addition, for all the samples, air was blown using a nozzle having a diameter of 1 mmφ from the laser light irradiation side at a flow rate of 15 L/min. Here, the distance (gap) between the strengthened glass sheet and the nozzle tip was set to 3 mm.

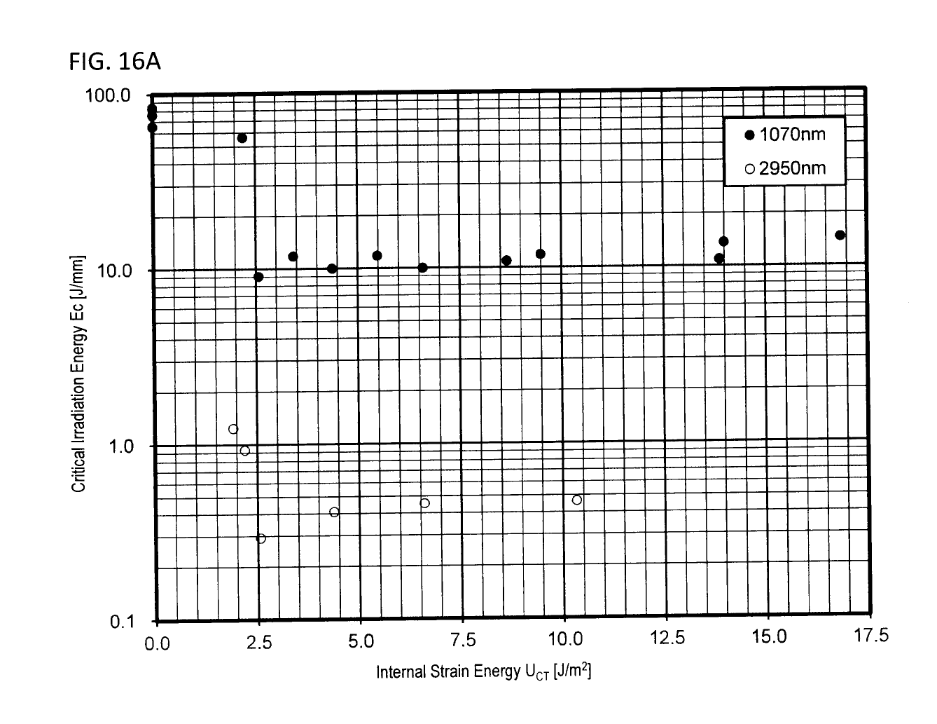

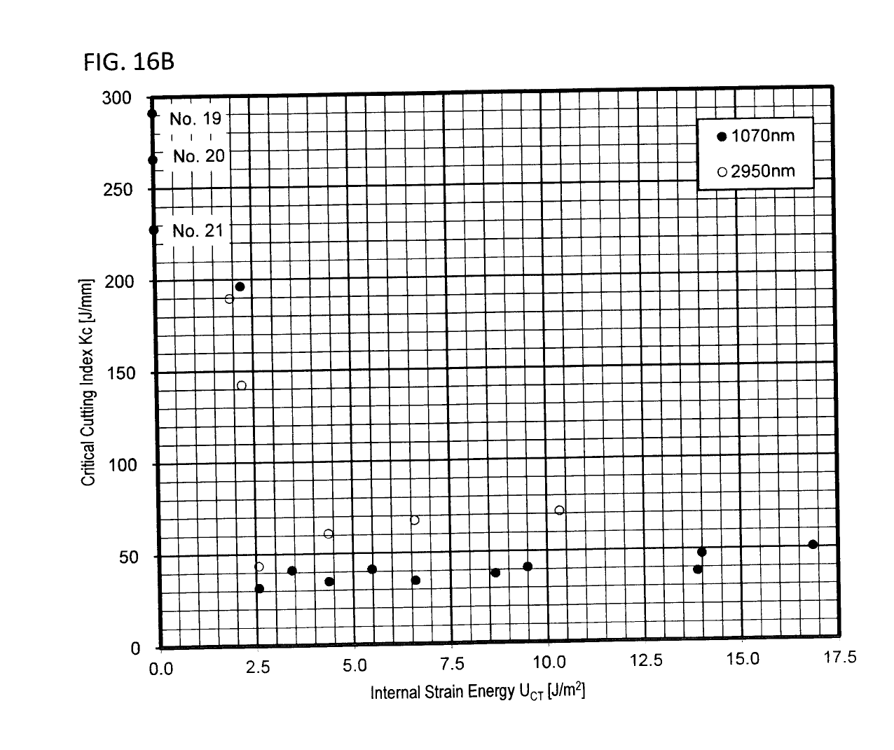

FIG. 16A is a graph illustrating the internal strain energy U_{CT} dependency of the critical irradiation energy Ec illustrated in the table of FIG. 15. In FIG. 16A, the horizontal axis indicates the internal strain energy U_{CT} (J/m²), and the vertical axis indicates the critical irradiation energy Ec (J/mm). In FIG. 16A, the black dots indicate Samples 1 to 11 and 18 to 21 (laser wavelength λ=1070 nm), and the white dots indicate Samples 12 to 17 (laser wavelength λ=2950 nm).

As illustrated in FIGS. 15 and 16A, in a case where the laser wavelength λ, was 1070 nm, at an internal strain energy U_{CT} of the strengthened glass sheet of 2.5 J/m² or more, the critical irradiation energy Ec was stable in the range of 9 J/mm to 15 J/mm (Samples 1 to 10). On the contrary, at an internal strain energy U_{CT} of the strengthened glass sheet of less than 2.5 J/m², the critical irradiation energy Ec abruptly (specifically, approximately several times) increased up to 56 J/mm (Sample 11). In response to the increase in the critical irradiation energy Ec, in Sample 11, the cutting accuracy also deteriorated. From the above-described results, it was found that, in a case where the strengthened glass sheet was cut, it was possible to accurately cut the glass sheet using a small irradiation energy by setting the internal strain energy U_{CT} to 2.5 J/m² or more.

Furthermore, it was not possible to cut the non-strengthened glass sheet of Sample 18. That is, at a sheet thickness t of 0.7 mm or less and a beam diameter φ of 0.5 mm, it was not possible to cut the samples of the non-strengthened glass sheet. In addition, for Sample 19 having a beam diameter φ of 0.8 mm, the critical irradiation energy Ec was 83 J/mm, for Sample 20 having a beam diameter φ of 1.0 mm, the critical irradiation energy Ec was 76 J/mm, and for Sample 21 having a beam diameter φ of 2.0 mm, the critical irradiation energy Ec was 65 J/mm. That is, an increase in the beam diameter was accompanied by a decrease in the critical irradiation energy Ec. Since an increase in the beam diameter further separates the center of the laser light and the tip position of the crack, the cutting accuracy is degraded. Therefore, in the cutting of the strengthened glass sheet, the beam diameter φ is preferably set to the sheet thickness t or less, and more preferably set to ½ or less of the sheet thickness t.

From the graph of FIG. 16A, it can be considered that, at an internal strain energy U_{CT} near 2.5 J/m², the cutting mode was changed. Specifically, it is considered that, as the crack propagation energy for cutting the strengthened glass sheet, in the case of an internal strain energy U_{CT} of less than 2.5 J/m², in addition to the internal strain energy, the irradiation energy of the laser light is required (refer to FIG. 12), and, in the case of an internal strain energy U_{CT} of 2.5 J/m² or more, only the internal strain energy is required (refer to FIG. 13).

In addition, a change in the laser wavelength λ from 1070 nm to 2950 nm improves the absorption coefficient α of the strengthened glass sheet from 0.011 mm⁻¹ to 0.59 mm⁻¹. Therefore, as illustrated in FIGS. 15 and 12, at an internal strain energy U_{CT} of 2.5 J/m² or more, it is possible to decrease the critical irradiation energy Ec by as much as two orders of magnitude from approximately 9 J/mm to 15 J/mm (Samples 1 to 10) to 0.3 J/mm to 0.5 J/mm (Samples 12 to 15).

As described above, when the laser wavelength is set to near 3000 nm, it is possible to increase the absorption coefficient α without degrading the transparency, and to reduce the irradiation energy. Therefore, the efficiency of heating is improved. Therefore, it is not necessary to significantly change the irradiation conditions of the laser light depending on the composition of the strengthened glass sheet.

Furthermore, as described above, it is possible to place the strengthened glass sheet to be cut on a table larger than the strengthened glass sheet, and cut the strengthened glass sheet in a more stable state. In addition, since the amount of transmitted light is extremely decreased, a treatment therefor also becomes unnecessary. Furthermore, since the amount of reflected light on the edge surface of the strengthened glass sheet is also extremely decreased, an adverse influence is not easily caused.

In a case where the laser wavelength λ was 2950 nm, similar to the case of 1070 nm, at an internal strain energy U_{CT} of the strengthened glass sheet of less than 2.5 J/m², the critical irradiation energy Ec abruptly increased to approximately 0.9 J/mm to 1.2 J/mm or more (Samples 16 and 17). In response to the increase in the critical irradiation energy Ec, in Samples 16 and 17, the cutting accuracy also deteriorated. From the above-described results, it was found that, in a case where the strengthened glass sheet was cut at a laser wavelength λ of 2950 nm, it was possible to accurately cut the glass sheet using a small irradiation energy by setting the internal strain energy U_{CT} to 2.5 J/m² or more.

Here, in the critical irradiation energy Ec, the energy used for cutting is the energy Ea absorbed in the strengthened glass sheet (hereinafter, referred to as the critical absorbed energy). The critical absorbed energy Ea (J/mm) can be expressed by the following equation using the critical irradiation energy Ec (J/mm), the absorption coefficient α (mm⁻¹), and the thickness t₂ (mm) on the basis of the Lambert-Beer law.

Ea=Ec×exp(−α×t₂) Equation 4

As described in FIG. 15, the values of the critical absorbed energy Ea (J/mm) are almost identical to the cases at the laser wavelengths λ of 2950 nm and 1070 nm.

In order to exclude the influence of the thickness or material of the strengthened glass sheet, and further generalize the mechanism, a thermal stress (critical compressive stress) σc generated by the internal heating (temperature change ΔT) at the critical absorbed energy Ea will be considered. The critical compressive stress σc is a minimum compressive stress necessary for cutting. The critical compressive stress σc turns into a compressive stress in a case where the internal residual tensile stress CT is used as the standard, and thus is expressed as the “critical compressive stress”. However, as illustrated in FIGS. 12 and 13, in a case where the critical compressive stress is considered in terms of a stress generated in the sheet thickness central part of the strengthened glass sheet, the critical compressive stress is expressed as the total force of the internal residual tensile stress CT and the critical compressive stress σc, and thus there is a case in which the critical compressive stress turns into a tensile stress.

As illustrated in FIGS. 12 and 13, the critical compressive stress σc has a Gaussian distribution-like profile. The integrated value (the area of the hatched section in FIGS. 12 and 13) of the critical compressive stress σc determines the cutting possibility. At the same internal strain energy U_{CT}, the integrated value of the critical compressive stress σc is considered to be constant regardless of the thickness t and material of the strengthened glass sheet. Since the width of the profile of the critical compressive stress σc is proportional with the beam diameter φ, it may be considered that the integrated value of the critical compressive stress σc is also proportional with σc×φ.

Here, for simplification, it is assumed that the sheet thickness t of the strengthened glass sheet does not change even by internal heating, and the strengthened glass sheet is restrained between the front surface layer 13 and the back surface layer 15, and thus, the critical compressive stress σc is generated. That is, a both edge restraint model is considered.

The critical compressive stress σc (MPa) can be expressed by the following Equation 5 using the Young's modulus Y (MPa), the linear expansion coefficient σ_{L} (K⁻¹), and the temperature change ΔT (K).

σc=Y×α_{L}×ΔT Equation 5

In addition, the temperature change ΔT of the strengthened glass sheet caused by the supply of the critical absorbed energy Ea can be determined from ΔT=(critical absorbed energy)/(the heat capacity of the strengthened glass sheet in a laser irradiation part).

Here, when the laser irradiation area is represented by S₁ (mm²), the (critical absorbed energy) can be expressed by Ea×S₁/φ (J) using the critical absorbed energy per unit area Ea/φ (J/mm²) obtained by dividing the critical absorbed energy Ea (J/mm) by φ (mm).

In addition, when the area of the heating region in the strengthened glass sheet is represented by S₂ (mm²), (the heat capacity of the strengthened glass sheet in the laser irradiation part) can be expressed by S₂×t₂×ρ×c (J/K) using the thickness t₂ (mm), density ρ (g/mm³), and the specific heat c (J/g/K) of the strengthened glass sheet.

Therefore, the temperature change ΔT (K) can be expressed by the following Equation 6.

$$\begin{matrix}Δ T = Ea \times {S}_{1} / ( {S}_{2} \times {t}_{2} \times ρ \times c ) / φ \\ = ( {S}_{1} / {S}_{2} ) \times Ea / ( {t}_{2} \times ρ \times c ) / φ\end{matrix} \qquad Equation 6$$

The critical compressive stress σc (MPa) can be expressed by the following Equation 7 by substituting Equation 6 into Equation 5.

σc=(S₁/S₂)×Y×α_{L}×Ea/(t₂×ρ×c)/φ Equation 7

Here, for simplification, when S₁/S₂ is assumed to be constant, σc×φ, which is proportional with the integrated value of the critical compressive stress σc to be determined, can be expressed by the following Equation 8.

σc×φ∝Ea×(Y×α_{L})/(t₂×ρ×c)=Kc Equation 8

Kc in Equation 8 is named as the critical cutting index. As the value of the critical cutting index Kc indicating the critical value at which the glass sheet can be cut decreases, cutting becomes easier, and as the value of the critical cutting index Kc increases, cutting becomes more difficult. As described above, the cutting property can be determined using the irradiation energy E (J/mm) of the laser light per unit length described in Equation 3.

All of the Young's modulus Y, the linear expansion coefficient α_{L}, the density ρ, and the specific heat c constituting the critical cutting index Kc are dependent on temperature, but the values at room temperature are used as indexes.

The critical cutting index Kc (N/mm) is described in the rightmost column of FIG. 15.

FIG. 16B is a graph illustrating the internal strain energy U_{CT} dependency of the critical cutting index Kc illustrated in the table of FIG. 15. In FIG. 16B, the horizontal axis indicates the internal strain energy U_{CT} (J/m²), and the vertical axis indicates the critical cutting index Kc (N/mm). In FIG. 16B, the black dots indicate Samples 1 to 11 and 18 to 21 (laser wavelength λ=1070 nm), and the white dots indicate Samples 12 to 17 (laser wavelength λ=2950 nm).

As illustrated in FIGS. 15 and 16B, at an internal strain energy U_{CT} of the strengthened glass sheet of 2.5 J/m² or more, the critical cutting index Kc was stable at near 50 N/mm regardless of the laser wavelength λ (Samples 1 to 10 and 12 to 15). On the contrary, at an internal strain energy U_{CT} of the strengthened glass sheet of less than 2.5 J/m², the critical cutting index Kc reached near 150 N/mm (Sample 16) or 200 N/mm (Samples 11 and 17). Furthermore, in the non-strengthened glass sheets, the critical cutting index Kc exceeded 200 N/mm (Samples 18 to 21). Here, as the beam diameter decreases, the critical cutting index Kc increases, and, at a beam diameter of 0.5 mm or less, cutting becomes impossible (Sample 18).

In response to the increase in the critical cutting index Kc, the cutting accuracy also deteriorated. From the above-described results, it was found that, in a case where the strengthened glass sheet was cut, it was possible to accurately cut the glass sheet using a small irradiation energy by setting the internal strain energy U_{CT} to 2.5 J/m² or more. In addition, since an increase in the beam diameter further separates the center of the laser light and the tip position of the crack, the cutting accuracy is degraded. Therefore, the beam diameter φ is preferably set to the sheet thickness t₂ (mm) or less, and more preferably set to ½ or less of the sheet thickness t₂ (mm).

The cutting index K at the irradiation energy E (J/mm) per unit irradiation area can be expressed by the following Equation 9 by substituting Ec in Equation 4 by E, and then substituting Ea in Equation 8 with Equation 4. Here, when the cutting index K is the critical cutting index Kc or more, cutting becomes possible.

K=E×exp(−α×t₂)×(Y×α_{L})/(t₂×ρ×c) Equation 9

Furthermore, when Equation 3 is substituted into Equation 9, the following Equation 10 is obtained.

K=Pe/v×exp(−α×t₂)×(Y×α_{L})/(t₂×ρ×c) Equation 10

FIG. 16B shows that, when the internal strain energy U_{CT} is 2.5 J/m² or more, the critical cutting index Kc is approximately 50 N/mm, and therefore cutting is sufficiently possible at an irradiation energy E satisfying the cutting index K≦150 N/mm. On the other hand, FIG. 16B shows that, when the internal strain energy U_{CT} is less than 2.5 J/m², the critical cutting index Kc reaches 150 N/mm or more, and therefore cutting becomes impossible or difficult at an irradiation energy E satisfying the cutting index K≦150 N/mm. When the internal strain energy U_{CT} is set to 2.5 J/m² or more, and then, the irradiation energy E is set to satisfy the cutting index K≦150 N/mm, accurate cutting is possible using a small irradiation energy. When the irradiation energy E is set to satisfy the cutting index K≦5100 N/mm, more accurate cutting is possible using a smaller amount of irradiation energy. Meanwhile, when the cutting index K is too small, it is not possible to control the crack propagation, and thus, cutting becomes impossible. Therefore, it becomes possible to stably cut the glass sheet by setting the irradiation energy E to satisfy the cutting index K≧5 N/mm.

### Example 2

In Example 2, the influence of the laser wavelength λ on the attachment of a foreign substance, which increased the absorptivity of the laser light, was investigated.

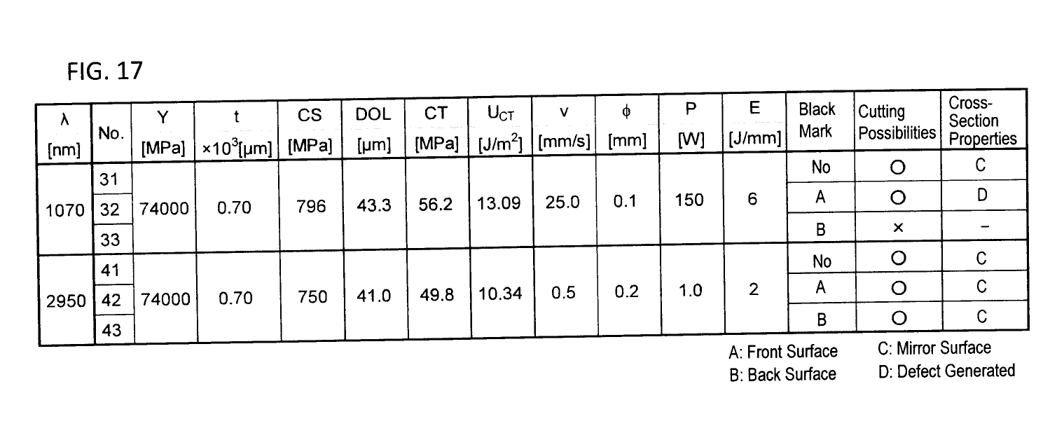

FIG. 17 is a table illustrating laser wavelengths λ, internal strain energies U_{CT}, irradiation energies E, a variety of conditions for deriving both, the presence or absence of a black mark as a foreign substance, cutting possibilities, and cross-section properties in Samples 31 to 33 and 41 to 43. Specifically, from the left column of the table, the laser wavelength λ (nm), sample numbers, Young's moduli Y (MPa), the thicknesses t (μm) of the strengthened glass sheets, the surface compressive stress CS (MPa), the thicknesses DOL (μm) of the front surface layer and the back surface layer, the internal residual tensile stress CT (MPa), the internal strain energy U_{CT} (J/m²), the scanning rate v (mm/s) of the laser light, the beam diameter φ (mm) of the laser light, the laser output P (W), the irradiation energy E (J/mm), the presence or absence of a black mark, cutting possibility, and cross-section properties are sequentially illustrated. The internal strain energy U_{CT} and the irradiation energy E were determined in the same manner as in Example 1. However, for simple evaluation, the reflectivity r was set to 0%.

As described in FIG. 17, in Samples 31 to 33, a fiber laser (central wavelength band: 1070 nm) was used, and in Samples 41 to 43, a Cr:ZnSe laser (central wavelength band: 2950 nm) in which a mid-infrared light parametric oscillator was used as a light source of the laser light was used.

As described in FIG. 17, in Samples 31 and 41, there was no black mark attached to both the front surfaces (laser light incident side) and back surfaces (laser light emission side) of the strengthened glass sheets. In Samples 32 and 42, the black marks were attached only to the front surfaces. In Samples 33 and 43, the black marks were attached only to the back surfaces. The black marks were attached using an oil-based marker.

As described in FIG. 17, in Samples 31 to 33, the beam diameter φ was set to 0.1 mm, and in Samples 41 to 43, the beam diameter φ was set to 0.2 mm. In addition, while not described in FIG. 17, for all the samples, air was blown using a nozzle having a diameter of 1 mmφ from the laser light irradiation side at a flow rate of 15 L/min. Here, the distance (gap) between the strengthened glass sheet and the nozzle tip was set to 3 mm.

As described in FIG. 17, at a laser wavelength λ of 1070 nm, the irradiation energy E was 6 J/mm (Samples 31 to 33); however, at a laser wavelength λ of 2950 nm, the irradiation energy E was decreased to 2 J/mm (Samples 41 to 43).

In Samples 31 and 41 including no black mark, both glass sheets could be cut regardless of the laser wavelength, and the cross-section properties were also mirror surfaces, that is, favorable.

In Sample 32 in which the laser wavelength λ was 1070 nm, the presence of the black mark on the front surface increased the absorptivity of the laser light in the part, and cutting was possible, but defects were caused on the cut surface.

In addition, in Sample 33 in which the laser wavelength λ was 1070 nm, the black mark was attached to the back surface, and thus, cutting was not possible.

On the contrary, in Samples 42 and 43 in which the laser wavelength λ was 2950 nm, in spite of the attachment of the black mark, both glass sheets could be cut, and the cross-section properties were also mirror surfaces, that is, favorable.

As described above, it was found that, when the laser wavelength is increased to near 3000 nm, the absorptivity of the laser light increases. Therefore, even when the absorptivity of the laser light is increased due to a foreign substance attached to the front surface or back surface, the proportion of the change of the absorptivity is small, and therefore, an adverse influence is not easily caused.

### Example 3

In Example 3, the influence of the formation of a black matrix film on the critical irradiation energy Ec in a case where the laser wavelength λ was set to 2950 nm was investigated. Similarly to Example 1, the glass sheet was cut along the cutting-scheduled line illustrated in FIG. 14.

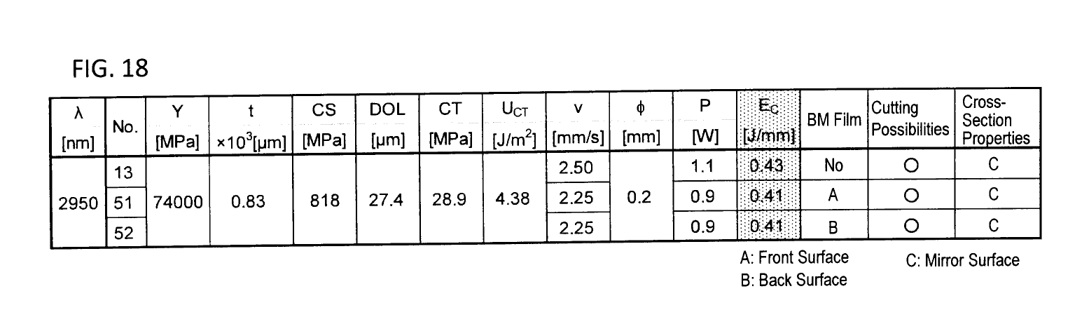

FIG. 18 is a table illustrating laser wavelengths λ, internal strain energies U_{CT}, critical irradiation energies E_{C}, a variety of conditions for deriving both, the presence or absence of the formation of a black matrix (BM) film, cutting possibilities, and cross-section properties in Samples 51 and 52. In addition, for comparison, the results of Sample 13 in Example 1 are also described.

Specifically, from the left column of the table of FIG. 18, the laser wavelength λ (nm), sample numbers, Young's moduli Y (MPa), the thicknesses t (μm) of the strengthened glass sheets, the surface compressive stress CS (MPa), the thicknesses DOL (μm) of the front surface layer and the back surface layer, the internal residual tensile stress CT (MPa), the internal strain energy U_{CT} (J/m²), the scanning rate v (mm/s) of the laser light, the beam diameter φ (mm) of the laser light, the laser output P (W), the critical irradiation energy Ec (J/mm), the presence or absence of the BM film, cutting possibility, and cross-section properties are sequentially illustrated. The internal strain energy U_{CT} and the critical irradiation energy Ec were determined in the same manner as in Example 1. However, for simple evaluation, the reflectivity r was set to 0%.

The critical irradiation energy Ec was obtained by repeating cutting while the irradiation energy E was gradually changed. At this time, the scanning rate v (mm/s) of the laser light was changed at intervals of 0.25 mm/s while the laser output P(W) was fixed.

As described in FIG. 18, a Cr:ZnSe laser (central wavelength band: 2950 nm) in which a mid-infrared light parametric oscillator was used as a light source of the laser light was used. In Sample 51, a BM film was formed on the front surface, and in Sample 52, a BM film was formed on the back surface. In addition, similar to Sample 13 in Example 1 illustrated in FIG. 18, air was blown using a nozzle having a diameter of 1 mmφ from the laser light irradiation side at a flow rate of 15 L/min. Here, the distance (gap) between the strengthened glass sheet and the nozzle tip was set to 3 mm.

As described in FIG. 18, in Samples 51 and 52 in which the BM film was formed, the critical irradiation energies Ec were all 0.41 J/mm, and the critical irradiation energy Ec of Sample 13 in Example 1 in which the BM film was not formed was 0.43 J/mm which was not so different from those of the above-described samples. From the above-described results, it was found that, in a case where the laser wavelength λ was set to 2950 nm, the critical irradiation energy Ec was not influenced by the formation of the BM film and the film-formed surfaces, and accurate cutting was possible using a small irradiation energy although the BM film was formed.

Thus far, the prevent invention has been described in accordance with the above-described embodiments, but the present invention is not limited to the constitutions of the embodiments, and it is needless to say that a variety of modifications, corrections, and combinations that can be made by those skilled in the art can be made within the scope of the inventions in the claims of the present application.

The present application is based on Japanese Patent Application No. 2012-153400 filed on Jul. 9, 2012, and Japanese Patent Application No. 2012-261909 filed on Nov. 30, 2012, the contents of which are incorporated herein by reference.

### INDUSTRIAL APPLICABILITY

According to the present invention, the crack propagation by the internal residual tensile stress becomes dominant, and it is possible to accurately cut a strengthened glass sheet using a small irradiation energy.

### REFERENCE SIGNS LIST

10 Strengthened Glass Sheet
12 Front Surface
13 Front Surface Layer
14 Back Surface
15 Back Surface Layer
17 Intermediate Layer
20 Laser Light
22 Irradiation Region
25 Lens
28 Cooling Nozzle
30 Crack
40 Strengthened Glass Panel
41 to 44 Straight Section
45 Cutting Start Position
46 Cutting End Position
235 Cutting-Scheduled Line
C1 to C4 Corner Section

1. A method for cutting a strengthened glass sheet, comprising:
cutting a strengthened glass sheet including a front surface layer having a residual compressive stress, a back surface layer having a residual compressive stress and an intermediate layer which is formed between the front surface layer and the back surface layer and has an internal residual tensile stress CT (MPa), by moving an irradiation region of laser light with which the strengthened glass sheet is irradiated,
wherein a strain energy U_{CT} (J/m²) per unit area based on the internal residual tensile stress CT expressed by the following equation using a thickness DOL (μm) of the front surface layer and the back surface layer, a thickness t₁ (μm) of the strengthened glass sheet, and a Young's modulus Y (MPa) is 2.5 J/m² or more, and
a cutting index K (N/mm) expressed by the following equation using an output Pe (W) of the laser light incident on the strengthened glass sheet, a scanning rate v (mm/s) of the laser light, an absorption coefficient α (mm⁻¹) of the strengthened glass sheet with respect to the laser light, a thickness t₂ (mm) of the strengthened glass sheet, the Young's modulus Y (MPa), a linear expansion coefficient α_{L} (K⁻¹), a density ρ (g/mm³), and a specific heat c (J/g/K) is 150 N/mm or less:
U_{CT}={CT²×(t₁−2×DOL)}/(2×Y)
K=Pe/v×exp(−α×t₂)×(Y×α_{L})/(t₂×ρ×c).

2. The method for cutting a strengthened glass sheet according to claim 1, wherein a beam diameter of the laser light is equal to or less than the thickness of the strengthened glass sheet.

3. The method for cutting a strengthened glass sheet according to claim 1, wherein the strengthened glass sheet is cut by moving the irradiation region of the laser light while controlling propagation of a crack caused by the internal residual tensile stress by locally heating the intermediate layer at a temperature of an annealing point or lower using the laser light with which the strengthened glass sheet is irradiated, and generating a compressive stress in the intermediate layer.

4. The method for cutting a strengthened glass sheet according to claim 1, wherein the strengthened glass sheet and the laser light satisfy the condition of 0<α×t₂≦3.0.

5. The method for cutting a strengthened glass sheet according to claim 1, wherein a wavelength of the laser light is 250 nm to 5000 nm.

6. The method for cutting a strengthened glass sheet according to claim 5, wherein the wavelength of the laser light is 2500 nm to 3500 nm.

7. The method for cutting a strengthened glass sheet according to claim 1, wherein the strengthened glass sheet is cooled by blowing gas to the irradiation region of the laser light from an incident side of the laser light.

8. The method for cutting a strengthened glass sheet according to claim 1, wherein the strain energy U_{CT} per unit area based on the internal residual tensile stress CT is 60 J/m² or less.

9. The method for cutting a strengthened glass sheet according to claim 1, wherein the cutting index K is 5 N/mm or more.
